(19) United States
(12) Patent Application Publication
(10) Pub. No.: US 2025/0021405 A1
(43) Pub. Date: Jan. 16, 2025

(54) PARALLEL ARCHITECTURE WITH COMPILER-SCHEDULED COMPUTE SLICES

(71) Applicant: Ascenium, Inc., Mountain View, CA (US)

(72) Inventors: Tore Jahn Bastiansen, 4022 Stavanger (NO); Peter Aaser, 1394 Nesbru (NO); Trond Hellem Bø, 4072 Randaberg (NO)

(73) Assignee: Ascenium, Inc., Mountain View, CA (US)

(21) Appl. No.: 18/769,478

(22) Filed: Jul. 11, 2024

Related U.S. Application Data
(60) Provisional application No. 63/659,401, filed on Jun. 13, 2024.
(60) Provisional application No. 63/642,391, filed on May 3, 2024.
(60) Provisional application No. 63/571,483, filed on Mar. 29, 2024.
(60) Provisional application No. 63/554,233, filed on Feb. 16, 2024.
(60) Provisional application No. 63/537,024, filed on Sep. 7, 2023.
(60) Provisional application No. 63/526,252, filed on Jul. 12, 2023.

(51) Int. Cl. G06F 9/52

(52) U.S. Cl. CPC G06F 9/522

(57) ABSTRACT

Techniques for task processing based on compiler-scheduled compute slices are disclosed. A processing unit comprising compute slices, barrier register sets, a control unit, and a memory system is accessed. Each compute slice includes an execution unit and is coupled to other compute slices by a barrier register set. A first slice task is distributed to a first compute slice. A second slice task is allotted to a second compute slice, based on a branch prediction logic. The second compute slice is coupled to the first by a first barrier register set. Pointers are initialized. A compiled program is executed, beginning at the first compute slice. The second slice task can be executed in parallel while a branch decision is being made. If the branch decision determines that the second slice task is not the next sequential slice task, results from the second compute slice are discarded.

### RELATED APPLICATIONS

This application claims the benefit of U.S. provisional patent applications “Parallel Architecture With Compiler-Scheduled Compute Slices” Ser. No. 63/526,252, filed Jul. 12, 2023, “Semantic Ordering For Parallel Architecture With Compute Slices” Ser. No. 63/537,024, filed Sep. 7, 2023, “Compiler Generated Hyperblocks In A Parallel Architecture With Compute Slices” Ser. No. 63/554,233, filed Feb. 16, 2024, “Local Memory Disambiguation For A Parallel Architecture With Compute Slices” Ser. No. 63/571,483, filed Mar. 29, 2024, “Global Memory Disambiguation For a Parallel Architecture With Compute Slices” Ser. No. 63/642,391, filed May 3, 2024, and “Memory Dependence Prediction In A Parallel Architecture With Compute Slices” Ser. No. 63/659,401, filed Jun. 13, 2024.

Each of the foregoing applications is hereby incorporated by reference in its entirety.

### FIELD OF ART

This application relates generally to computer processing and more particularly to a parallel processing architecture with compiler-scheduled compute slices.

### BACKGROUND

Organizations believe data to be among their most valuable and highly protected assets. The sets of data or “datasets” are often unstructured and frequently immense. Processing the datasets achieves organizational missions and purposes including commercial, educational, governmental, medical, research, or retail purposes, to name only a few. The datasets can be analyzed for forensic and law enforcement purposes. Large and complex computational resources are used to process data to meet organizational needs, irrespective of organizational size or global reach. The computational resources include processors, data storage units, networking and communications equipment, telephony, power conditioning units, HVAC equipment, backup power units, and other essential equipment. Energy resource management is critical because the computational resources consume vast amounts of energy and produce prodigious heat. These resources are located in special-purpose, often high-security, installations. These installations more closely resemble high-security bases or even vaults than traditional office buildings. Not every organization requires vast computational equipment installations. However, all strive to provide resources to meet their data processing needs as quickly and cost effectively as possible.

Organizational operations include executing a wide variety of processing jobs. The processing jobs include computing billing and payroll, generating profit and loss statements, processing tax returns or election results, controlling experiments, analyzing research data, and generating academic grades, among others. The processing jobs consume computational resources in installations that typically operate 24×7×365. The types of data processed derive from the organizational missions. These processing jobs must be executed quickly, accurately, and cost-effectively. The processed datasets can be very large and unstructured, thereby saturating conventional computational resources. Processing an entire dataset may be required to find a particular data element. Effective dataset processing enables rapid and accurate identification of potential customers, or finetuning production and distribution systems, among other results that yield a competitive advantage to the organization. Ineffective processing wastes money by losing sales or failing to streamline a process, thereby increasing costs.

Organizations amass their data by implementing data collection techniques. The data is collected from various and diverse categories of individuals. Legitimate data collection techniques include “opt-in” strategies, where an individual signs up, creates an account, registers, or otherwise actively and willingly agrees to participate in the data collection. Some techniques are legislative, where citizens are required by a government to obtain a registration number to interact with government agencies, law enforcement, emergency services, and others. At other times, the individuals are unwitting subjects of data collection. Still other data collection techniques are more subtle or are even completely hidden, such as tracking purchase histories, visits to various websites, button clicks, and menu choices. Data can and has been collected by theft. Irrespective of the techniques used for the data collection, the collected data, if processed rapidly and accurately, is highly valuable to the organizations.

### SUMMARY

To greatly improve computer processing efficiency and data throughput, a compiled program can be processed using one or more processing units. The processing units include compute slices, barrier register sets, a control unit, and a memory system. The processing units can further include multicycle elements for multiplication, division, and square root computations; load-store units; arithmetic logic units (ALUs); storage elements; scratchpads; and other components. The components can communicate among themselves to exchange data, signals, and so on. These processing units are issued slice tasks from a control unit, which can make scheduling decisions, such as executing, committing, ready to commit, done, and so on, based on control signals from the processing units. As the control unit schedules slice tasks, a compiled program can be executed.

Techniques for task processing based on compiler-scheduled compute slices are disclosed. A processing unit comprising compute slices, barrier register sets, a control unit, and a memory system is accessed. Each compute slice includes an execution unit and is coupled to other compute slices by a barrier register set. A first slice task is distributed to a first compute slice. A second slice task is allotted to a second compute slice, based on a branch prediction logic. The second compute slice is coupled to the first by a first barrier register set. Pointers are initialized. A compiled program is executed, beginning at the first compute slice. The second slice task can be executed in parallel while a branch decision is being made. If the branch decision determines that the second slice task is not the next sequential slice task, results from the second compute slice are discarded.

A processor-implemented method for computer processing is disclosed comprising: accessing a processing unit comprising a plurality of compute slices, a plurality of barrier register sets, a control unit, and a memory system, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices; distributing a first slice task, by the control unit, to a first compute slice in the plurality of compute slices; allotting a second slice task, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets; initializing pointers, wherein a head pointer points to the first compute slice, and wherein a tail pointer points to the second compute slice; and executing a compiled program, wherein the executing begins at the first compute slice. Some embodiments include ignoring a result from the second compute slice, wherein a branch instruction in the first compute slice was mispredicted by the branch prediction logic. Some embodiments include flushing, in the second compute slice, information stored in a write buffer. Some embodiments include updating the tail pointer to point to the first compute slice, wherein a next sequential slice task is not distributed to the second compute slice. Some embodiments include committing a result of the first compute slice, by the control unit, wherein the first compute slice has completed execution.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a parallel architecture with compiler-scheduled compute slices.

FIG. 2 is a flow diagram for program execution.

FIG. 3 is a processing unit block diagram for compute slice control.

FIG. 4 illustrates a system block diagram for a ring configuration of compute slices.

FIG. 5 is a first illustration of executing slice tasks with slices.

FIG. 6 is a second illustration of executing slice tasks with slices.

FIG. 7 is a third illustration of executing slice tasks with slices.

FIG. 8 is a fourth illustration of executing slice tasks with slices.

FIG. 9 is a fifth illustration of executing slice tasks with slices.

FIG. 10 is a sixth illustration of executing slice tasks with slices.

FIG. 11 is a seventh illustration of executing slice tasks with slices.

FIG. 12 is an eighth illustration of executing slice tasks with slices.

FIG. 13 is a ninth illustration of executing slice tasks with slices.

FIG. 14 is a system diagram for a parallel architecture with compiler-scheduled compute slices.

### DETAILED DESCRIPTION

Modern day organizations have an ever-growing need for compute resources. The rise in the use of machine learning, and especially of large language models, has further compelled IT departments to provide needed compute resources to engineers and scientists. Data mining, image processing, genomic sequencing, autonomous vehicle technology, and virtual reality technology are just a few of the many technologies that have increased the need for additional compute power. In response, computer architectures have attempted to meet this need by increasing parallelism, increasing clock speeds, and proposing various architectures and extensions to provide task-specific processing. Additional technologies will be needed to provide additional compute power to serve current and next generation applications.

Organizations process often unstructured, varied, and frequently immense datasets in support of a wide variety of organizational missions and purposes. The missions and purposes include commercial, educational, governmental, medical, research, or retail missions and purposes, to name only a few. The datasets can also be analyzed for law enforcement and forensic purposes. Computational resources are configured by the organizations to meet various organizational needs. The organizations range in size from sole proprietor operations to large, international organizations. The computational resources include processors, data storage units, networking and communications equipment, telephony, power conditioning units, HVAC equipment, and backup power units, among other essential equipment. Energy resource management is also critical since the computational resources consume prodigious amounts of energy and produce copious heat. The computational resources can be housed in special-purpose, and frequently high-security, installations. These installations more closely resemble high-security installations or even vaults than traditional office buildings. Not every organization requires vast computational equipment installations, but all endeavor to provide resources to meet their data processing needs as quickly and cost effectively as possible.

To meet the high-performance needs of these applications, a processor-implemented method for computer processing is disclosed. Computer execution is enabled by parallel architecture with compiler-scheduled compute slices. A processing unit comprising a plurality of compute slices, a plurality of barrier register sets, a control unit, and a memory system is accessed, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices. A first slice task is distributed, by the control unit, to a first compute slice in the plurality of compute slices. A second slice task is allotted, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. A compiled program is executed, wherein the executing begins at the first compute slice.

An outcome of a branch operation can be predicted using branch prediction logic. The predicted outcome side of the branch operation can be executed in parallel while a branch decision is being made. The executing is accomplished by distributing and allotting slice tasks to compute slices within the processing unit. The distributing and allotting is determined by the control unit and can rely on static hints from the compiler. The code (or slice task) associated with the predicted outcome can be executed on a successor compute slice speculatively. The distributing and allotting distributes parallelized operations to the plurality of compute slices. The distributed parallelized operations can enable the parallel execution of the slice block containing the branch operation and the predicted side of the branch operation. Data access suppression can be used to prevent data accesses from being executed and can prevent the data accesses from leaving the processing unit. The branch decision determines which branch path or branch side to take based on evaluating an expression. The expression can include a logical expression, a mathematical expression, and so on. When the branch decision is determined, the control unit can check that the second slice task is a next sequential slice task in the compiled program. The checking is based on execution of the first compute slice. If the second slice task is the next sequential slice task, then execution can proceed. If the second slice task is not the next sequential slice task, then results from the second compute slice are discarded.

Programs that are executed by the compute slices within the processing unit can be associated with a wide range of applications. The applications can be based on data manipulation, such as image, video, or audio processing applications; AI and machine learning applications; business applications; data processing and analysis; and so on. The tasks that are executed can perform a variety of operations including arithmetic operations, shift operations, logical operations including Boolean operations, vector or matrix operations, tensor operations, and the like. The subtasks can be executed based on branch prediction, operation precedence, priority, coding order, amount of parallelization, data flow, data availability, compute element availability, communication channel availability, and so on. Slice tasks that comprise a compiled program are generated by a compiler. The compiler can include a general-purpose compiler, a hardware description-based compiler, a compiler written or “tuned” for the specific number of compute slices in the processor unit, a constraint-based compiler, a satisfiability-based compiler (SAT solver), and so on. Control is provided to the hardware by the control unit which allocates slice tasks to compute slices. Once issued, the slice tasks execute independently from the control unit and other compute slices until they are either halted by the control unit, indicate an exception, finish executing, etc.

The data manipulations are performed on a processing unit. The processing unit comprises a plurality of compute slices, a plurality of barrier register sets, a control unit, and a memory system. The compute slices within the processing unit can be implemented with central processing units (CPUs), graphics processing units (GPUs), application specific integrated circuits (ASICs), field programmable gate arrays (FPGAs), processing cores, or other processing components or combinations of processing components. The compute slices can include heterogeneous processors, homogeneous processors, processor cores within an integrated circuit or chip, etc. The compute slices can be coupled to local storage, which can include load-store units, local memory elements, register files, cache storage, etc. The cache, which can include a hierarchical cache such as an L1, L2, and L3 cache, can be used for storing data such as intermediate results, compute element operations, and the like. Any level of cache (e.g., L1, L2, L3, etc.) can be shared by two or more compute slices.

The processing unit comprises a plurality of compute slices, a plurality of barrier register sets, a control unit, and a memory system. The various elements of the processing unit can include compute elements, processors, or cores within an integrated circuit; processors or cores within an application specific integrated circuit (ASIC); cores programmed within a programmable device such as a field programmable gate array (FPGA); and so on. The processing unit can include homogeneous or heterogeneous processors. Each compute slice is coupled to a successor compute slice and a predecessor compute slice by a barrier register set. The coupling of the compute slices enables data communication between compute slices. Thus, the control unit can control data flow between the compute slices and can further control data commitment to the barrier register set and to memory outside of the processing unit.

A first slice task is distributed by the control unit to a first compute slice in the plurality of compute slices. The first slice task includes at least one branch operation. The branch operation, such as a conditional branch operation, can include an expression and two or more paths or sides. A second slice task is allotted, by the control unit, to a second compute slice in the plurality of compute slices. The allotting of the second slice task is based on a branch prediction logic within the control unit. The second slice task is the predicted next sequential slice task in the compiled program. The second slice task can be executed speculatively. The second compute slice is coupled to the first compute slice by a first barrier register set in the plurality of barrier register sets. The first barrier register set provides unidirectional communication between the first compute slice and the second compute slice. Thus, the first compute slice can write to the first barrier register set and the second compute slice can read from the first barrier register set. Pointers are used to determine which compute slices are issued to the first slice task and the second slice task. Pointers that point to compute slices are initialized. A head pointer points to the first compute slice, and a tail pointer points to the second compute slice. The head pointer and the tail pointer can be updated based on slice task execution status, branch operation outcome determination, and so on. A compiled program is executed, where the executing begins at the first compute slice. Executing multiple slice tasks on two or more compute slices enables parallelized operations. The parallelized operations enable parallel execution of the first slice task and the second slice task. The second slice task is the predicted outcome of the branch operation. The parallelized operations can include primitive operations that can be executed in parallel. A primitive operation can include an arithmetic operation, a logical operation, a data handling operation, and so on.

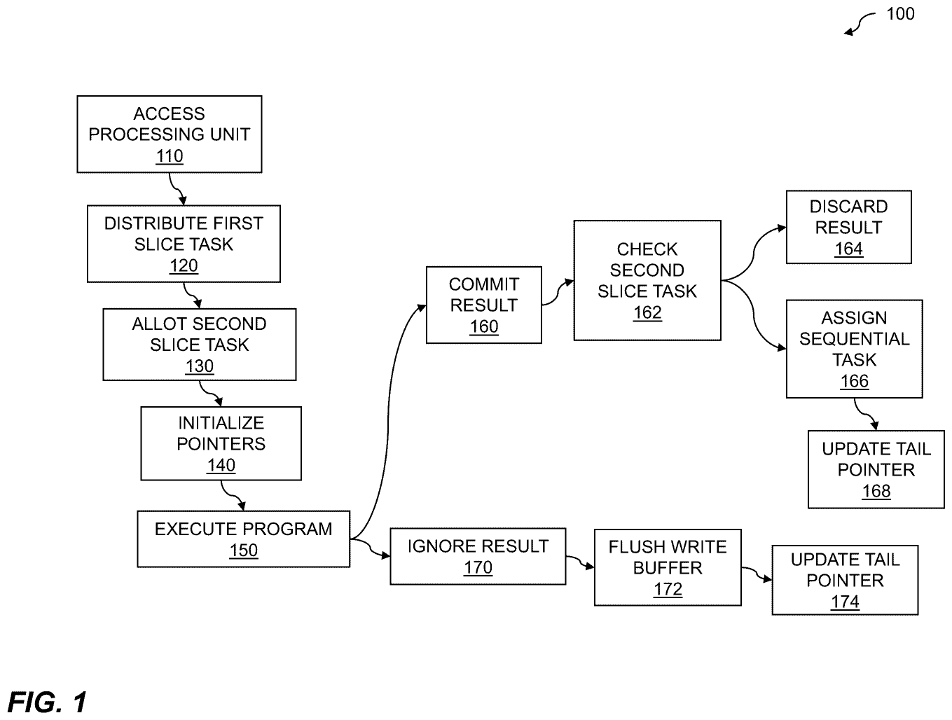

FIG. 1 is a flow diagram for a parallel architecture with compiler-scheduled compute slices. Compute slices within a processing unit can be issued blocks of code for execution call slice tasks. The slice tasks can be associated with a compiled program. The compiled program, when executed, can perform a variety of operations associated with data processing. The processing unit can include elements such as barrier register sets, a control unit, and a memory system. The processing unit can further interface with other elements such as ALUs, memory management units (MMUs), GPUs, multicycle elements (MEMs), and so on. The operations can accomplish a variety of processing objectives such as application processing, data manipulation, data analysis, modeling and simulation, and so on. The operations can accomplish artificial intelligence (AI) applications such as machine learning. The operations can manipulate a variety of data types including integer, real, and character data types; vectors, matrices, and arrays; tensors; etc.

The flow 100 includes accessing 110 a processing unit comprising a plurality of compute slices, a plurality of barrier register sets, a control unit, and a memory system, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices. The compute slices can be based on or include a variety of types of processors. The compute slices can include central processing units (CPUs), graphics processing units (GPUs), processors or processing cores within application specific integrated circuits (ASICs), processing cores programmed within field programmable gate arrays (FPGAs), and so on. In embodiments, compute slices within the processing unit have identical functionality. In other embodiments, the compute slices within the processing unit have different functionality. The compute slices can be coupled to a barrier register set which can enable data transfer between compute slices. The compute slices can share a variety of computational resources within the processing unit. In embodiments, the processing unit can include a ring configuration of compute slices and barrier registers. More than one processing unit can be accessed. Two or more processing units can be collocated on an integrated circuit or chip, on multiple chips, and the like. In embodiments, two or more processing units can be stacked to form a three-dimensional (3D) configuration. The stacking of the processing units can be accomplished using a variety of techniques. In embodiments, the three-dimensional processing units can be physically stacked. The 3D processing unit can comprise a 3D integrated circuit. In other embodiments, the three-dimensional processing unit is logically stacked. The logical stacking can include configuring two or more processing units to operate as if they were physically stacked.

The processing unit can further include a topology suited to machine learning computation. A topology for machine learning can include supervised learning, unsupervised learning, reinforcement learning, and other machine learning topologies. A topology for machine learning can include an artificial neural network topology. The compute slices can be coupled to other elements within the processing unit. In embodiments, the coupling of the compute elements can enable one or more further topologies. The other elements to which the compute slices can be coupled can include storage elements such as a scratchpad memory, one or more levels of cache storage, multiplier units, address generator units for generating load (LD) and store (ST) addresses, buffers, register files, and so on.

The compiler can include C, C++, or another language. The compiler can include a compiler written especially for the processing unit. The processing unit can run code written on an interpreted language such as Python. The coupling compute slices to successor compute slices enables clustering of compute resources; sharing of array elements such as cache elements, multiplier elements, or ALU elements; and the like. The compiler can be used to generate one or more slice tasks that can be mapped by the control unit, by assigning blocks of code to one or more compute slices. In embodiments, the compiler can map machine learning functionality to the processing unit. The machine learning can be based on a machine learning (ML) network, a deep learning (DL) network, a support vector machine (SVM), etc. In embodiments, the machine learning functionality can include a neural network (NN) implementation. The neural network implementation can include a plurality of layers, where the layers can include one or more of input layers, hidden layers, output layers, and the like. Depending on the type and size of a task that is compiled for execution on the processing unit, one or more of the compute slices can execute slice tasks, while other compute slices are unneeded by the particular task. A compute slice that is unneeded can be marked as idle. An idled compute slice requires no data and no further information. The idling of a compute slice can be accomplished using a control bit. The idling of compute slices within the processing unit can decrease power consumption of the processing unit. The slice tasks that are generated by the compiler can include a conditionality such as a branch. Each slice task can include one or more branch instructions. The branch can include a conditional branch, an unconditional branch, etc.

The flow 100 includes distributing a first slice task 120, by the control unit, to a first compute slice in the plurality of compute slices. The control unit can identify the first slice task, compute slice capabilities required to execute the slice task, and so on. In embodiments, each slice task can include a header. The header can include information about the slice task such as the length of code in the slice task. Discussed below, the first compute slice to which the first slice task is distributed can be indicated by a pointer. The flow 100 includes allotting a second slice task 130, by the control unit, to a second compute slice in the plurality of compute slices. The second compute slice can be a compute slice among idle compute slices within the processing unit. The first slice task and the second slice task can include instructions, operations, and so on. In embodiments, the first slice task and the second slice task can include a plurality of instructions and at least one branch instruction. Various techniques can be used to allot the second slice task. In embodiments, the allotting is based on a branch prediction logic within the control unit. The branch prediction logic can locate the branch instruction within the first slice task and can identify two or more branch paths that can be taken based on the evaluating the branch. The branch prediction logic can predict which branch path is the likely path and allot the branch path as the second slice task to the second compute slice. The branch prediction logic can use static hints from the compiler. In embodiments, the second compute slice is coupled to the first compute slice by a first barrier register set in the plurality of barrier register sets. The first barrier register set can enable unidirectional communication between the first or predecessor slice task and the second or successor slice task.

Slice tasks can be executed on the compute slices within the processing unit. Multiple slice tasks can be executed in parallel (e.g., speculatively). In embodiments, a successor slice can stall while waiting for a predecessor slice to update needed results and load them into a barrier register. The successor slice can then read the needed results to continue executing its slice task. To demonstrate this latter point, consider a usage example in which compute slice A, running slice task A processes input data and produces output data that is required by compute slice B, running slice task B. Thus, for correct results, slice task A must first generate the input required by slice task B before slice task B can execute on compute slice B. In this case, compute slice B can stall while waiting for results from the predecessor slice. Once the results are obtained, compute slice B can execute slice task B speculatively while slice task A proceeds. Compute slice C, however, holds slice task C that executes instructions that process the same input data as slice task A and produces its own output data. Thus, slice task C can be speculatively executed in parallel with slice tasks A and B. In embodiments, a load address buffer and a store buffer within a load-store unit associated with each compute slice can be used to prevent aliasing between compute slices when slice tasks are running in parallel.

The flow 100 includes initializing pointers 140, wherein a head pointer points to the first compute slice, and wherein a tail pointer points to the second compute slice. The pointers can be used to identify which compute slice was provided the first slice task. The tail pointer can identify which compute slice was allotted the second slice task. The head pointer and the tail pointer can be updated independently as discussed below. The tail pointer, for example, can be updated based on issuing further slice tasks, completion of execution of slice tasks, and the like. The flow 100 includes executing a compiled program 150, wherein the executing begins at the first compute slice. The first compute slice can be executing the first slice task. The second compute slice can begin executing the second slice task if there is data, other than data produced by the first slice task, that can be processed. If the second slice task does require data produced by executing the first slice task, then the second compute slice can wait for data to be produced by the first compute slice.

The flow 100 includes committing a result 160 of the first compute slice, by the control unit, wherein the first compute slice has completed execution. The committing the result can include committing the result to the memory system. The committing a result can include making the result available for reading at the output barrier register coupled between the first compute slice and the second compute slice. In embodiments, the barrier registers can be loaded with results from the predecessor task at any time results are ready. In other embodiments, the committing a result can occur once during execution of the slice task. The committing the result can include indicating that data in the barrier register set is ready for reading. In embodiments, a ready bit is set in the barrier register when results are written into the barrier register. Recall that the second slice task was originally identified for allotting to the second compute slice based on branch prediction hardware. The flow 100 includes checking 162, by the control unit, that the second slice task is a next sequential slice task in the compiled program, wherein the checking is based on execution of the first compute slice. Execution of the first slice task on the first compute slice includes determining a branch outcome for the branch instruction in the first slice task. The checking can be based on comparing the predicted branch decision to the actual branch decision. If the predicted branch decision matches the actual branch decision, then execution can proceed with the second slice task on the second compute slice. If the predicted outcome does not match the determined outcome, other actions can be taken.

The flow 100 includes discarding a result 164 from the second compute slice if the second slice task that was allotted to the second compute slice is not the next sequential slice task in the compiled program. Since the second slice task was incorrectly predicted by the prediction logic, then the second slice task results are irrelevant and can therefore be discarded. The discarding can include deleting the results, overwriting the results, updating a pointer, and so on. Another slice task can be assigned to the second compute slice. The flow 100 includes assigning, to the second compute slice, the next sequential slice task 166 in the compiled program, wherein the assigning is accomplished by the control unit. The next sequential slice task can include a slice task associated with the taken branch path corresponding to the branch decision that was determined in the first slice task. The next sequential slice task can include a third slice block or later slice task. The flow 100 further includes updating the tail pointer 168 to point to the second compute slice. The tail pointer can require updating to point to the second compute slice because the further slice task could have been issued based on predicted branch outcome associated with a branch in the second slice task. As additional slice tasks are issued, the tail pointer can be updated to point to the compute slices that received the additional slice tasks. Since the second slice task code was determined to not be the next sequential slice task for execution, then any slice task what was issued based on a predicted branch decision associated with the second slice task is no longer relevant, and any results can be discarded.

The flow 100 includes ignoring a result 170 from the second compute slice, wherein a branch instruction in the first compute slice was mispredicted by the branch prediction logic. The branch prediction logic can predict an execution sequence for slice tasks based on predicting branch decisions. In a usage example, a first slice task is issued to a first compute slice. The prediction logic can predict a branch outcome and can select a second slice task for execution based on the branch prediction. Further slice tasks can be issued based on a branch prediction for the second slice task, a prediction for a third slice task, and so on. If the branch prediction for the branch associated with the first slice task was incorrect, then any results generated by executing successive slice tasks such as the second slice task or further slice tasks can be ignored. The flow 100 further includes flushing, in the second compute slice, information stored in a write buffer 172. Since writing, by the second compute slice, to one or more registers within the second barrier register set can occur on or before an end of execution of the second slice task, then any data that was written by the second compute slice is irrelevant. The data can be flushed, overwritten, cleared, zeroed, etc. The flow 100 includes updating the tail pointer 174 to point to the first compute slice. The updating the tail pointer can indicate that the second compute slice is idle and can be issued a new slice task by the control unit.

Memory access operations such as loads can be subject to latency, where the latency can be associated with congestion on a bus, with a transit time associated with a crossbar switch, with latency associated with the storage in which the requested data is located, and so on. The memory access latency can vary by orders of magnitude depending on where the data is located. The memory in which the data can be located can include memory local to the processing unit, a scratchpad, buffers within a load-store unit, a cache memory, a memory system, etc. Further, the memory implementation can include memory such as SRAM, DRAM, non-volatile memory, etc., and can directly influence latency. Memory access operation latency can be a cause of memory access hazards.

Discussed in detail below, a change in memory access hazards can result from a change in operation execution sequence. In embodiments, the change of memory access hazards can result from a branch operation decision. Since execution of all sides of a branch can begin prior to a branch decision being made, various memory access operations that are associated with each side of the branch operation can be initiated. When the branch decision is made, then the taken path can proceed, and memory access operations associated with the taken side can likewise proceed. The memory access operations associated with the untaken side or side are terminated, thereby changing memory access hazards.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

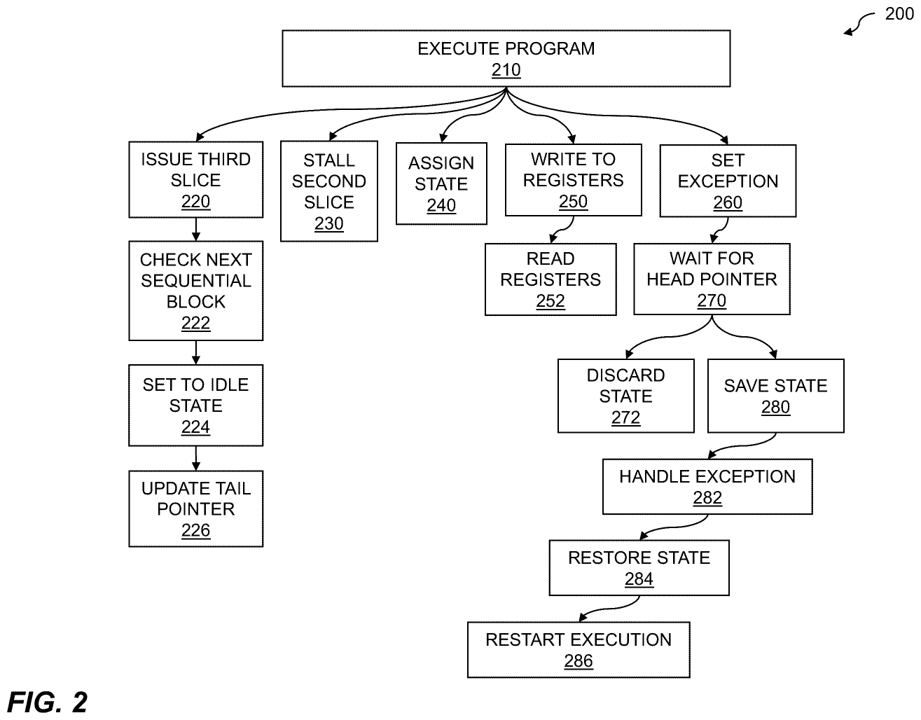

FIG. 2 is a flow diagram for program execution. Discussed previously, a program can be compiled by compiler. The compiled program can be executed by portioning it into slice tasks, where the slice tasks can be issued to compute slices within a processing unit by a control unit. Each slice task includes a branch decision. A branch prediction is made for the branch decision within the first slice task, and further slice tasks are assigned additional compute slices based on that branch decision. When the branch decision is determined for the branch in the first slice task, then a control unit checks that the second slice task is a next sequential slice task in the compiled program, where the checking is based on execution of the first compute slice. The branch decision can indicate that the second slice task was the next sequential slice task or was not the next sequential slice task. If the second slice task that was allotted to a compute slice in the processing unit is not the next sequential slice task in the compiled program, then the results from the compute slice are discarded. If the second slice task that was allotted to a compute slice in the processing unit is the next sequential slice task in the compiled program, then the execution of the slice task on the compute slice proceeds. Additional slice tasks can be assigned to additional successive compute slices.

The program execution is enabled by parallel architecture with compiler-scheduled compute slices. A processing unit comprising a plurality of compute slices, a plurality of barrier register sets, a control unit, and a memory system is accessed, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices. A first slice task is distributed, by the control unit, to a first compute slice in the plurality of compute slices. A second slice task is allotted, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. A compiled program is executed, wherein the executing begins at the first compute slice.

Memory access operations such as load operations and store operations can originate from one or more compute slices within a processing unit. One or more buffers, such as load address buffers, store buffers, and the like can be used to provide data to one or more elements such as compute slices within a processing unit. Slice tasks can be issued by a control unit to compute slices within the processing unit. Once issued, the slice tasks execute independently from the control unit and other compute slices until they are either halted by the control unit, indicate an exception, finish executing, etc.

Two compute slices can be coupled to a barrier register set. The barrier register set can capture data generated by a compute slice, can hold data for processing by a compute slice, and so on. The barrier registers can enable data flow between an upstream (or predecessor) compute slice and a downstream (or successor) compute slice. The plurality of compute slices and the plurality of barrier register sets can be coupled in a ring configuration. The ring configurations of the compute slices and the barrier register sets can further include one or more topologies. A topology can be mapped by the compiler. The topology mapped by the compiler can include a graph such as a directed graph (DG) or directed acyclic graph (DAG), a Petri Net (PN), etc. In embodiments, the compiler maps machine learning functionality to the array of compute elements. The machine learning can be based on supervised, unsupervised, and semi-supervised learning; deep learning (DL); and the like. In embodiments, the machine learning functionality can include a neural network implementation. The compute slices can be coupled to other elements within the processing unit. In embodiments, the coupling of the compute slices can enable one or more topologies. The other elements to which the compute slices can be coupled can include storage elements such as one or more levels of cache storage, multiplier units, address generator units for generating load (LD) and store (ST) addresses, queues, and so on. The compute slices can each be coupled to a load-store unit. The compiler can include C, C++, or another language. The processing unit can run code written on an interpreted language such as Python. The compiler can include a compiler written especially for the processing unit with which the compute slices are associated. The coupling of each compute slice to other elements within the processing unit enables sharing of elements such as cache elements, multicycle elements (multiplication, logarithm, square root, etc.), ALU elements, or a control unit; communications within the processing unit; and the like.

The flow 200 includes executing a compiled program 210. The task can include a data processing task, a machine learning task, and so on. The task can be compiled by a high-level compiler such as a C or C++ compiler; a hardware description language compiler such as a Verilog™ compiler; a compiler designed for a processing unit; interpreted with a language such as Python; and so on. Slice tasks associated with the compiled program can be issued to compute slices within a processing unit. The slice tasks can include a first slice task, a second slice task, and so on. The executing begins at the first compute slice. The flow 200 includes issuing a third slice task 220 to a third compute slice in the plurality of compute slices. The third slice task is issued by the control unit. The issuing the third slice task is based on the branch prediction logic. The branch prediction logic attempts to predict the outcome of a branch decision associated with a previously issued slice task. The third compute slice can be successive to a compute slice pointed to by a tail pointer. The tail pointer can point to the last, previously issued slice task.

The flow 200 includes checking 222, by the control unit, that the third slice task is a next sequential slice task in the compiled program. Recall that the third slice task was issued based on a prediction by the branch prediction logic. The branch prediction can be determined for a branch with a previously issued slice task such as the second slice task. The check that the third slice task is a next sequential slice task in the compiled program can be based on the execution of the second compute slice which was completed. Completing execution by the second compute slice includes determining a branch decision for a branch operation associated with the second slice task. The determined branch decision can be checked against the predicted branch result. The flow 200 includes setting the third compute slice to an idle state 224 if the third slice task that was issued is not the next sequential slice task in the compiled program. In a usage example, the predicted branch decision and the determined branch decision may not match, so the third slice task is not the next sequential slice task in the compiled program. The third slice task is not needed, so the compute slice to which the third slice task was issued can be idled or cancelled by the control unit. The flow 200 further includes updating the tail pointer 226 to point to the second compute slice. The tail pointer is updated to point to the predecessor compute slice that was issued a slice task which was in the slice task sequence.

The executing of slice tasks issued to compute slices within the processing unit is based on availability of required data. The data can be provided from a memory system via a load-store unit. The required data can also be provided by a barrier register set coupled between two compute slices. In embodiments, the second compute slice can complete execution of the second slice task, wherein the first compute task has not completed execution. Variations in compute time, task complexity, memory, and so on can result in later slice tasks completing before earlier slice tasks assigned by the control unit. The flow 200 further includes stalling 230, by the second compute slice, until one or more results from the first slice task are available. The one or more results can be generated during execution of the first slice task. The one or more results of the first slice task can become available upon execution of the branch decision associated with the first slice task. The inputs, for which the second compute slice has stalled, are required inputs for the second slice task. The required inputs for the second slice task are updated by the first compute slice.

The flow 200 includes assigning, by the control unit, a state 240 to each compute slice in the plurality of compute slices. The state that is assigned is one of idle, executing, holding, or done. While four states are presented, other numbers of states can be assigned by the control unit. The idle state can indicate that a compute slice is idle and available to receive a slice task from the control unit. The executing state can indicate that the compute slice is executing the slice task, generating data, determining one or more branch decisions, and the like. The holding state can indicate that a compute slice has executed the slice task issued to it, but the compute slice has not yet committed the result. Committing the result can include making the data generated by the first compute slice executing the first slice task available to the second compute slice. The data can be made available by loading one or more barrier registers. The done state can indicate that execution of a slice task has completed, that a branch decision has been determined, that generated data has been committed, etc.

The flow 200 includes writing 250, by the first compute slice, to one or more registers within the first barrier register set, one or more results from the first slice task which are required inputs for the second slice task. Recall that a barrier register set is coupled between the first compute slice and the second compute slice. The first slice task issued to the first compute slice can generate one or more results as the slice task is executed. The writing results can occur during execution, when the branch decision associated with the first slice task is determined, and so on. In embodiments, the writing can occur on or before the end of execution of the first slice task. The second slice task issued to the second compute slice can execute in parallel with the execution of the first slice task on the first compute slice. The second slice task can require data such as results generated by the first slice task. The flow 200 includes reading 252, by the second compute slice, from the one or more registers within the first barrier register set, the one or more results from the first slice task. While the second compute slice is waiting for results from the first compute slice, the second compute slice can operate on other data. The other data can include prior results, data from the load-store unit, and so on. Other embodiments can include stalling, by the second compute slice, until one or more results from the first slice task, which are required inputs for the second slice task, are updated by the first compute slice. Execution of the second slice task on the second compute slice can resume when the execution of the first slice task on the first compute slice is completed.

The flow 200 includes setting an exception flag 260, by at least one compute slice in the plurality of compute slices, wherein a slice task distributed to the at least one compute slice caused an exception to occur. An exception flag can be set due to control hazards, data hazards, and so on. A control exception can include a missing slice task, a slice task issued to a compute slice which is not functioning as the next sequential slice task, and so on. A data exception can include missing data, an invalid data operation, a memory page fault, and the like. An exception can include a recoverable exception or a nonrecoverable exception. Note that since slice tasks other than the first slice task assigned to the first compute slice are assigned speculatively, only an exception signaled by the first slice task must be handled. The flow 200 includes waiting 270, by the at least one compute slice, until the head pointer indicates that the at least one compute slice is active. If the at least one compute slice is inactive, then the exception may no longer be relevant. If the at least one compute slice is active, then the exception warrants handling. The flow 200 includes discarding a state 272 of the at least one compute slice, wherein the exception is not recoverable. An unrecoverable exception can include an illegal operation, data not found, and so on.

The flow 200 includes saving 280, by the control unit, the state of the at least one compute slice, wherein the exception is recoverable. Noted previously, the state can include a state associated with a compute slice, where the state can include idle, executing, holding, or done. The state can further include a scratchpad state, internal register state, and so on. The states of the load-store unit, scratchpads, and internal registers can include the contents of these storage elements. The flow 200 includes handling the exception 282, wherein the exception is recoverable. A recoverable exception can include a page fault, a cache miss, and the like. The exception handling can include resolving the page fault with one or more memory system accesses, resolving a cache miss by searching for an address in increasing levels of cache or the memory system, etc. The flow 200 includes restoring 284, by the control unit, the state that was saved to the at least one compute slice. In a usage example, a page fault can be resolved by accessing the memory system and loading needed data into the load-store unit. With the fault resolved, the contents of internal registers and other storage can be stored. The flow 200 further includes restarting execution 286, by the at least one compute slice, of the slice task that was distributed. The restarting can restart execution of a slice task on the compute slice pointed to by the head pointer, restarting predicted slice tasks issued to other compute slices, etc.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

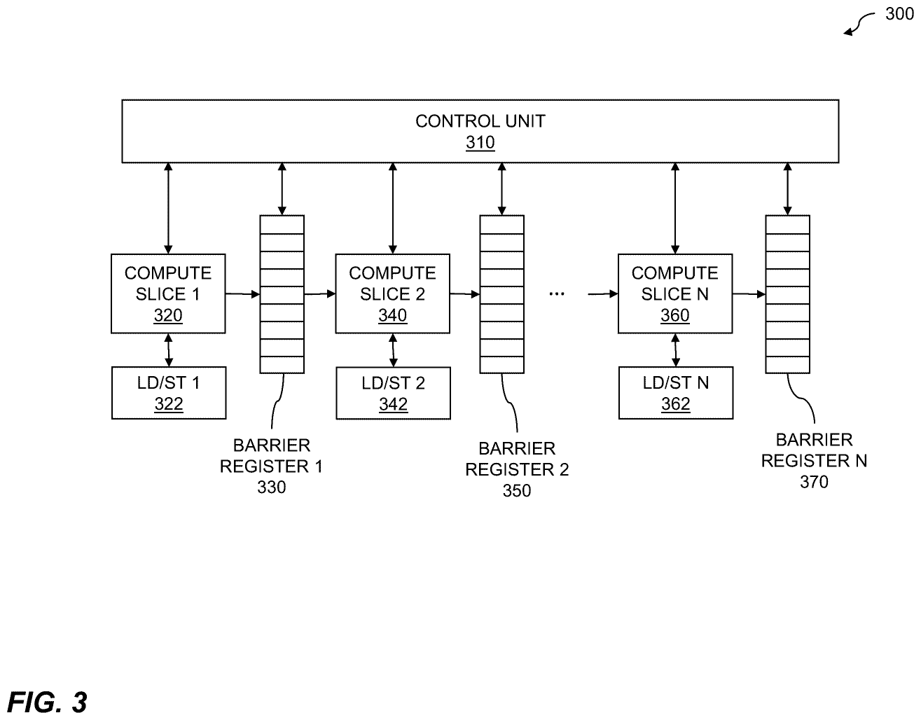

FIG. 3 is a processing unit block diagram for compute slice control. A processor unit can be used to process data for applications such as image processing, audio and speech processing, artificial intelligence and machine learning, and so on. The processor unit includes a variety of elements, where the elements include compute slices, a control unit, a memory system, busing and networking, and so on. The compute slices can obtain data for processing. The data can be obtained from the memory system, cache memory, a scratchpad memory, and the like. Compute slices can be coupled together using a barrier register, where a first compute slice can only write to the barrier register and a second compute slice can only read from the barrier register. The control unit can control data access, data processing, etc. by the compute slices. Compute slice control enables a parallel architecture with compiler-scheduled compute slices. A processing unit comprising a plurality of compute slices, a plurality of barrier register sets, a control unit, and a memory system is accessed, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices. A first slice task is provided, by the control unit, to a first compute slice in the plurality of compute slices. A second slice task is allotted, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. A compiled program is executed, wherein the executing begins at the first compute slice.

Compiled programs can be executed on a parallel processing architecture. Some slice tasks associated with the program, for example, can be executed in parallel, while others have to be properly sequenced. The sequential execution and the parallel execution of the tasks are dictated in part by the existence of or absence of data dependencies between tasks. In a usage example, compute slice A, running slice task A, processes input data and produces output data that is required by compute slice B, running slice task B. Thus, for correct results, slice task A must first generate the input required by slice task B before slice task B can execute on compute slice B. In this case, compute slice B can stall while waiting for results from the predecessor slice. Once the results are obtained, compute slice B can execute slice task B speculatively while slice task A proceeds. Compute slice C, however, holds slice task C that executes instructions that process the same input data as slice task A and produces its own output data. Thus, slice task C can be speculatively executed in parallel with slice tasks A and B. The execution of tasks can be based on memory access operations, where the memory access operations include data loads from memory, data stores to memory, and so on. The execution of tasks can further be based on data loads to a barrier register set and data stores to a barrier register set. If, in the example just recited, slice task B were to attempt to access and process data prior to slice task A producing the data required by slice task B, a hazard would occur. Thus, hazard detection and mitigation can be critical to successful parallel processing. In embodiments, the hazards can include write-after-read, read-after-write, and write-after-write conflicts. The hazard detection can be based on identifying memory access operations that access the same address. The hazard detection can include checking between store buffers and load address buffers within a load-store unit coupled to each compute slice.

Data can be moved between a memory such as a memory data cache, and storage elements associated with the processing unit. The storage elements associated with the processing unit can include scratchpad memory, register files, and so on. The storage elements associated with the processing unit can include barrier register sets. Memory access operations can include loads from memory, stores to memory, memory-to-memory transfers, etc. The storage elements can include a local storage coupled to one or more compute slices, storage associated with the array, cache storage, a memory system, and so on.

Compute slice control can include hazard detection and mitigation. The hazard mitigation can be based on distributing and allotting slice tasks to compute slices. One or more hazards, which can be encountered during memory access operations, can result when two or more memory access operations attempt to access the same memory address. Access hazards can also occur while committing data to a barrier register and reading data from the barrier register. While multiple loads (reads) from an address may not create a hazard, combinations of loads and stores to the same address are problematic. Hazard detection and mitigation techniques enable memory access operations to be performed while avoiding hazards. The memory access operations, which can be performed using load-store units associated with each compute slice, can include loading data from memory and storing data to memory. The data is loaded from memory to supply data slice tasks executing on compute slices. The data can be required or generated by slice tasks associated with programs to be executed on a processing unit. Data produced by the slice tasks can be stored back to the memory.

In the processing unit block diagram 300, the processing unit can include a control unit 310. The control unit can be used to control one or more compute slices, barrier registers, and so on associated with the processing unit. The control unit can operate based on receiving a set of slice tasks from a compiler. The compiler can include a high-level computer, a hardware language compiler, a compiler developed for use with the processing unit, and so on. The control unit can distribute and allocate slice tasks to compute slices associated with the processing unit. The control unit can be used to commit a result of a slice task to a barrier register when execution of the slice task has been completed. The control unit can perform checking operations. The checking operations can check that a slice task is a next sequential slice task in a compiled program. The checking can be based on execution of a first compute slice. The control unit can perform assigning operations. The assigning operations can include assigning the next sequential slice task in the compiled program to a second compute slice, assigning a third slice task to a third compute slice, and so on. The control unit can perform state assignment operations. Embodiments can include assigning, by the control unit, a state to each compute slice in the plurality of compute slices, wherein the state is one of idle, executing, holding, or done. The assigned states can be used to determine whether a compute slice is ready to receive a slice task, data is ready to be committed, etc. The state of a compute slice can be used for exception handling techniques. The exception handling techniques can be associated with nonrecoverable exceptions and recoverable exceptions.

The processing unit can include a plurality of compute units. The compute units can be issued, by the control unit, to slice tasks for execution. The slice tasks can include blocks of code associated with a compiled program generated by the compiler. In the figure, the compute slices include compute slice 1 320, compute slice 2 340, and compute slice N 360. The number of compute slices that can be included in the processing unit can be based on a processing architecture, a number of processor cores on an integrated circuit or chip, and the like. A load-store unit can be associated with each compute slice. The load-store unit can be used to provide load data obtained from a memory system for processing on the associated code slice. The load-store unit can be used to hold store data generated by the compute slice and designated for storing in the memory system. The load-store unit can include load-store unit 1 322 associated with compute slice 1 320, load-store unit 2 342 associated with compute slice 2 340, and load-store unit N 362 associated with compute slice N 360. As the number of compute slices changes for a particular processing unit architecture, the number of load-store units can change correspondingly.

The processing unit can include a plurality of sets of barrier registers. The barrier registers can be used to hold load data to be processed by a compute slice, to receive store data generated by a compute slice, and so on. In embodiments, a second compute slice can be coupled to a first compute slice by a first barrier register set in the plurality of barrier register sets. In the block diagram, barrier register 1 330 can couple compute slice 2 340 to compute slice 1 320, barrier register 2 350 can couple compute slice 3 (not shown) to compute slice 2 340, barrier register N 370 can couple compute slice N+1 (not shown) to compute slice N 360, etc. Since slice tasks can be issued to compute slices in an order such as from left to right, a left-hand compute slice or predecessor compute slice only has to write to a barrier register coupled to a right-hand compute slice or successor. That is, a successor compute slice does not have to write to a predecessor compute slice, nor does a predecessor compute slice have to read from a successor compute slice. In embodiments, the predecessor compute slice can be to the left of the successor compute slice. In further embodiments, the plurality of compute slices and the plurality of barrier register sets can be coupled in a ring configuration. Thus, barrier register N 370 can be coupled between compute slice N 360 and compute slice 1 320.

Data movement, whether loading, storing, transferring, etc., can be accomplished using a variety of techniques. In embodiments, memory system access operations can be performed outside of processing unit, thereby freeing the compute slices with the processing unit to execute slice tasks. Memory access operations, such as autonomous memory operations, can preload data needed by one or more compute slices. The preloaded data can be placed in buffers associated with compute slices that require the data. In additional embodiments, a semi-autonomous memory copy technique can be used for transferring data. The semi-autonomous memory copy technique can be accomplished by the processing unit which generates source and target addresses required for the one or more data moves. The processing unit can further generate a data size such as 8, 16, 32, or 64-bit data sizes, and a striding value. The striding value can be used to avoid overloading a column of storage components such as a cache memory.

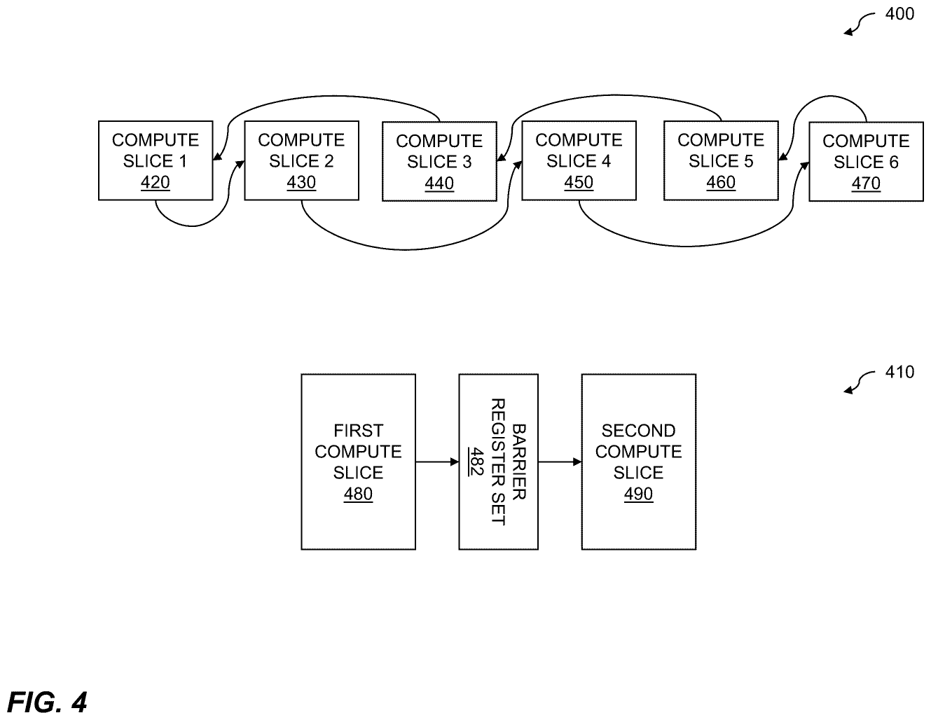

FIG. 4 illustrates a system block diagram for a ring configuration of compute slices. Described previously and throughout, a processing unit can be used to process a compiled program. The program can be associated with processing applications such as image processing, audio processing, and natural language processing applications. The processing can be associated with artificial intelligence applications such as machine learning. The processing unit can include various elements. Among other elements, the processing unit can comprise compute slices that are coupled to barrier register sets. A barrier register set can be established between two processor slices and can be used to hold data for processing by a compute slice, can receive committed effects such as data and branch decisions from the compute slices and so on. Pointers such as a head pointer and a tail pointer can be used to direct blocks of code issued by a control unit to the compute slices for execution. The compute slices and the barrier register sets can be coupled in a ring configuration. The ring configuration of the compute slices and the barrier register sets enable a parallel architecture with compiler-scheduled compute slices. A processing unit comprising a plurality of compute slices, a plurality of barrier register sets, a control unit, and a memory system is accessed, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices. A first slice task is provided, by the control unit, to a first compute slice in the plurality of compute slices. A second slice task is allotted, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. A compiled program is executed, wherein the executing begins at the first compute slice. The first slice can be pointed to by the head pointer.

In the system block diagram 400, a ring configuration of compute slices is shown. The compute slices within the ring configuration can include compute slice 1 420, compute slice 2 430, compute slice 3 440, compute slice 4 450, compute slice 5 460, compute slice 6 470, and so on. While six compute slices are shown, the ring of compute slices can also comprise more or fewer compute slices. The ring configuration can be accomplished using an integrated circuit or chip, a plurality of compute slice cores, a configurable chip, and the like. The ring configuration can be based on a regularized circuit layout, equalized interconnect lengths, and so on. A compute slice can be coupled to a second slice 410. A first compute slice 480 can be coupled to a second compute slice 490 using a barrier register set 482. The barrier register set can include a register set within a plurality of barrier register sets. Each compute slice of 400 and 410 can be coupled to a load-store unit (not shown). The load-store unit can handle data and instruction transfers between the compute slices and a memory system. Further, each compute slice can be coupled to a control unit (not shown). The control unit can enable loading and execution of slice tasks, loading and storing data in barrier registers, etc.

Discussed previously, each compute slice can independently execute a block of code called a slice task. The slice tasks that can be associated with the compute slices can be associated with a compiled program. The execution of the slice tasks can be controlled by a local program counter associated with each compute slice. Communication between a slice and its immediate neighbors, such as a predecessor compute slice and a successor compute slice, is accomplished using a barrier register set. Recall that a control unit that can control the compute slices can ensure that slice task order is issued in one direction such as from left to right. As a result, a compute slice is not required to write to a predecessor compute slice, nor to read from a successor compute slice. In a usage example, the first compute slice can only write to the barrier register and the second compute slice can only read from the barrier register. This architectural technique can ensure that a compute slice that requires input data from a predecessor compute slice can read valid data. That is, the first compute slice generates data, branch decisions, etc., and writes this information to the input of the barrier register while the output of the register remains unchanged. The data being read at the output of the barrier register will remain valid while the second compute slice is processing data. The results from the first compute slice are not committed until after the first compute slice has completed execution and the second compute slice has obtained its data. The committing is performed by the control unit. This technique eliminates a race condition such as a write-before-read race condition.

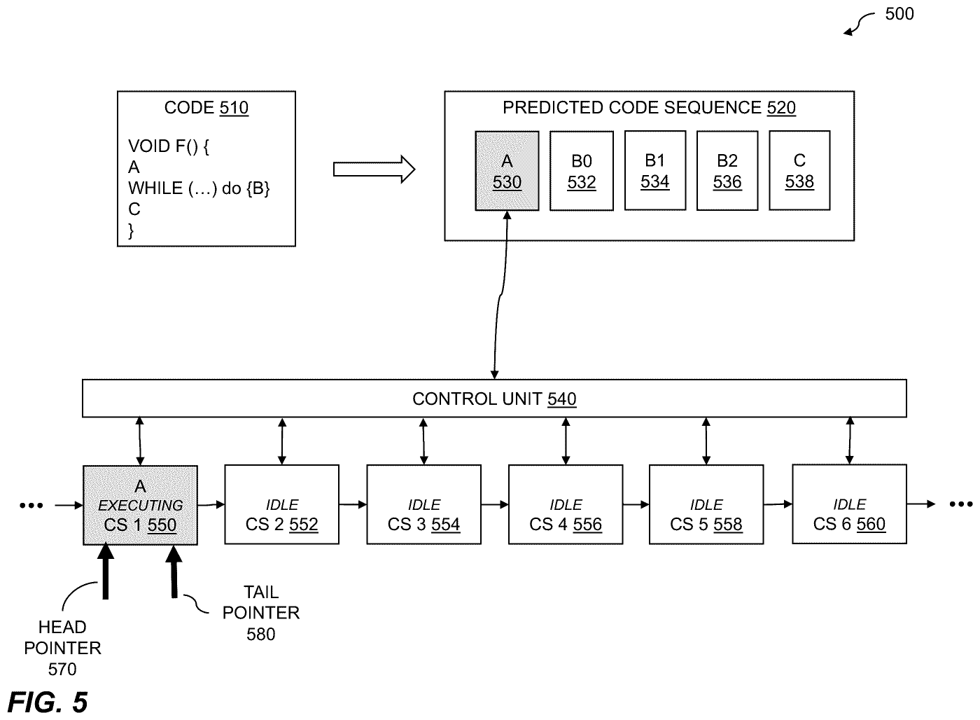

FIG. 5 is a first illustration of executing slice tasks with slices. Slice tasks can be distributed and allotted by a control unit to compute slices in a processing unit. Each slice task can include a branch operation. The control unit can distribute and allocate the slice tasks based on branch operation predictions. Execution of slice tasks can be performed in parallel on two or more compute slices. Results of executing a slice task are committed by the control unit when a compute slice has completed execution of a slice task. A branch operation associated with the slice task is evaluated and the control unit determines whether a slice task provided or allotted onto another compute slice is the next sequential slice task in a compiled program. The next sequential slice task can be the predicted next sequential slice task. If the provided or allotted slice task was the correctly predicted slice task, then execution continues. If the provided or allotted slice task was mispredicted, then results of the mispredicted slice task are discarded. The execution of slice tasks is enabled by a parallel architecture with compiler-scheduled compute slices. A processing unit comprising a plurality of compute slices, a plurality of barrier register sets, a control unit, and a memory system is accessed, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices. A first slice task is distributed, by the control unit, to a first compute slice in the plurality of compute slices. A second slice task is allotted, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets. Pointers are initialized, wherein a head pointer points to the first compute slice, and wherein a tail pointer points to the second compute slice. A compiled program is executed, wherein the executing begins at the first compute slice.

This figure and the subsequent eight figures show execution of example code. The example code can be executed as slice tasks on compute slices. Executing slice tasks using compute slices is shown 500. Example code 510 includes a loop such as a while-do loop. The while-do loop can be executed a number of times, and may include numerous instructions, where the number of times the while-do loop is executed can be based on an arithmetic expression, a logical operation, and so on. In embodiments, there are no value dependencies between iterations of the loop, so each iteration of the while-do loop can be executed independently. The continue predicate is known only at the end of each iteration. The continue predicate can act as a branch operation. Thus, the execution order of the iterations of the code can be based on predicting branch operation outcomes. A predicted slice task sequence is shown 520. The predicted slice task sequence can include slice task A 530, slice task B0 532 (e.g., the first iteration of the instruction sequence B), slice task B1 534, slice task B2 536, and slice task C 538. The slice tasks can be distributed to compute slices by a control unit 540. The control unit can distribute and allot slice tasks to compute slices. In this example, the slice tasks can include slice task A, slice tasks B0, B1, and B2, and slice task C.

The control unit 540 can be coupled to compute slices and can assign slice tasks to the compute slices. The compute slices can include CS 1 550, CS 2 552, CS 3 554, CS 4 556, CS 5 558, and CS 6 560. While six compute slices are shown, the control unit can be coupled to other numbers of compute slices. In embodiments, a compute slice can be coupled to a second compute slice by a barrier register (not shown). A barrier register can include a barrier register within a plurality of barrier registers. The barrier register can hold data generated by the first compute slice, provide data to the second compute slice, and so on. The compute slices can be coupled in a variety of configurations. In embodiments, the plurality of compute slices and the plurality of barrier register sets are coupled in a ring configuration. Assume that initially, each control slice within a plurality of control slices can be in an idle state. The control unit can distribute one or more instructions from the predicted code sequence to the compute slices. In the example, the control unit can distribute slice task A 530 to the compute slice pointed to by the head pointer 570. In the example, the compute slice pointed to by the head pointer is CS 1 550. Slice task A can begin execution. At this point, the tail pointer 580 can also point to the same compute slice as the head pointer. This coincidence of pointers can be due to only one task slice having been distributed to the compute slices. As additional slice tasks are assigned to compute slices, the tail pointer can be moved to point to the most recently distributed or allotted slice task. The distributing and allotting of further instructions is described in the following figures.

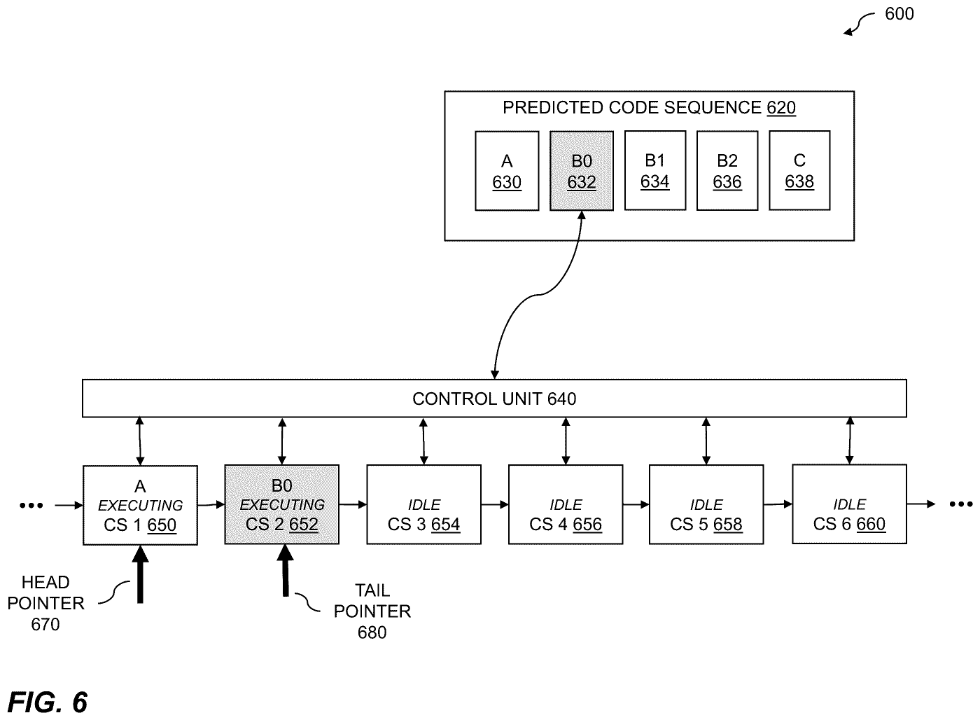

FIG. 6 is a second illustration of executing slice tasks with compute slices. In the illustration 600, a slice task from a predicted code sequence 620 can be allotted to a second compute slice. The instructions that comprise the predicted code sequence can be determined from the example code 510 discussed previously. The predicted code sequence can include slice task A 630, B0 632, B1 634, B2 636, and C 638. A control unit 640 can be coupled to one or more compute slices. The compute slices can include compute slice (CS) 1 650, CS 2 652, CS 3 654, CS 4 656, CS 5 658, and CS 6 660. Compute slice CS 1 can be executing slice task A as discussed previously. The head pointer 670 can remain set to point to compute slice CS 1. Slice task B0 can be allotted by the control unit to a second compute slice. In the example, slice task B0 is allotted by the control unit to CS 2. Instruction B0 can begin execution on compute slice CS 2. Further, the tail pointer 680 can be updated to point to the compute slice on which slice task B0 is executing, CS 2. The remaining compute slices, CS 3, CS 4, CS 5, and CS 6 can remain idle.

Both compute slices, CS 1 and CS 2 can be executing A and B0 respectively in parallel. The two instructions can execute in parallel when the instructions are independent of one another. The independence of the instructions can be attributed to there not being data dependencies between the two instructions that are executing. Recall that the instructions in the instruction sequence 620 are the instructions predicted to be executed. The predictions can be based on predicting outcomes of branch instructions. Thus, the compute slice 1 that is executing A can be the only slice that executes code which can be guaranteed to be part of the program or program order. In embodiments, compute slice CS 1 can be designated as the “head slice” and can be pointed to by the head pointer 670. Conversely, every compute slice to the right of the head slice potentially is speculative. In a usage example, a branch decision made for a branch operation associated with slice task A can be made as part of executing slice task A. If the predicted branch outcome is correct, then execution of slice task B0 can proceed. If the predicted branch outcome was mispredicted, then other actions can be taken with respect to executing instruction B0.

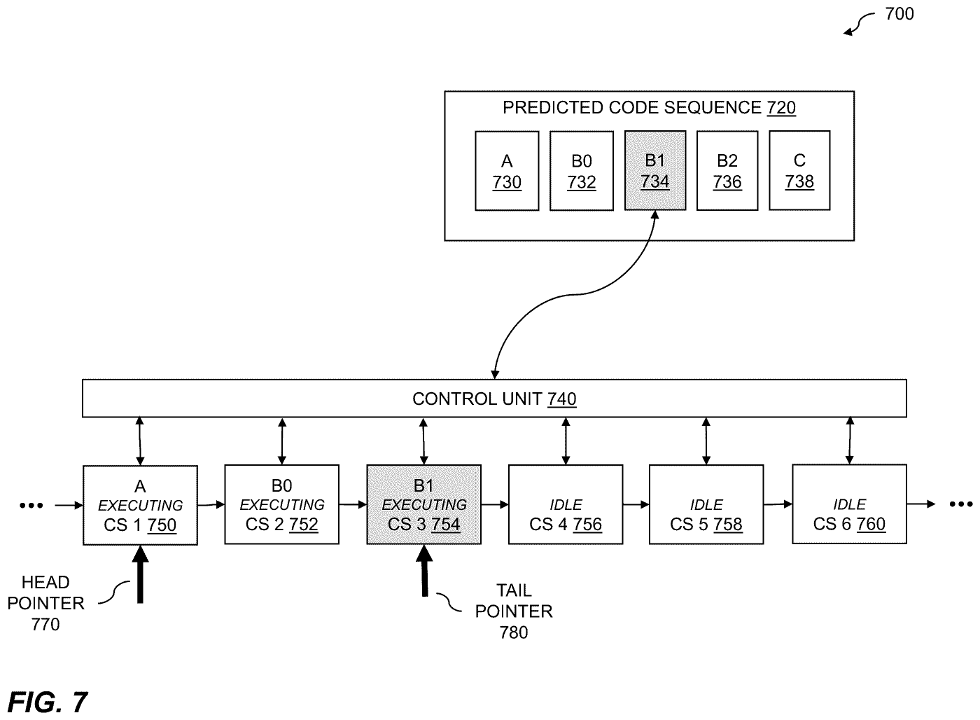

FIG. 7 is a third illustration of executing slice tasks with compute slices. In the illustration 700, continuing with the distributing and allotting slice tasks to compute slices, further slice tasks can be issued to compute slices. In the example, an additional slice task from a predicted code sequence 720 can be allotted to a third compute slice. The slice tasks that comprise the predicted code sequence can be determined from the example code 510 discussed above. The predicted code sequence can include slice tasks A 730, B0 732, B1 734, B2 736, and C 738. A control unit 740, as discussed previously, can be coupled to one or more compute slices. The one or more compute slices can include compute slice (CS) 1 750, CS 2 752, CS 3 754, CS 4 756, CS 5 758, and CS 6 760. Compute slice CS 1 can continue executing slice task A as discussed previously. The head pointer 770 can remain set to point to compute slice CS 1. Slice task B0 can continue executing on compute slice CS 2. Slice task B1 can be allotted by the control unit to a third compute slice. Slice task B1 can be issued by the control unit 740 to compute slice CS 3. Slice task B1 can begin execution on compute slice CS 3. In embodiments, the issuing of slice task B1 can be based on the branch prediction logic. The third compute slice is successive to a compute slice pointed to by the tail pointer. The tail pointer can be updated to point to the compute slice on which slice task B1 is executing, CS 3. The remaining compute slices, CS 4, CS 5, and CS 6 can remain idle. In this figure, slice tasks A, B0, and B1 can be executing in parallel. The executing of B0 and B1 can continue speculatively while awaiting a branch decision for instruction A and a branch decision for instruction B0, respectively.

In embodiments, the second compute slice can complete execution of the second slice task, which in this example is represented by slice task B0. Further, the first compute slice has not completed execution. Embodiments can include checking, by the control unit, that the third slice task is a next sequential slice task in the compiled program, based on the execution of the second compute slice which was completed. If the predicted code sequence was correct, slice task B1 is indeed the next instruction in the sequence. If instruction B1 was mispredicted, then other actions can be taken. Embodiments can include setting the third compute slice to an idle state if the third slice task that was issued is not the next sequential slice task in the compiled program. Since the third slice task, here slice task B1, was determined not to be the next slice task (discussed below), then executing slice task B1 can be suspended by idling CS 3. Data associated with instruction B1 can be ignored, flushed, deleted, and so on. Embodiments can further include updating the tail pointer 780 to point to the second compute slice CS 2.

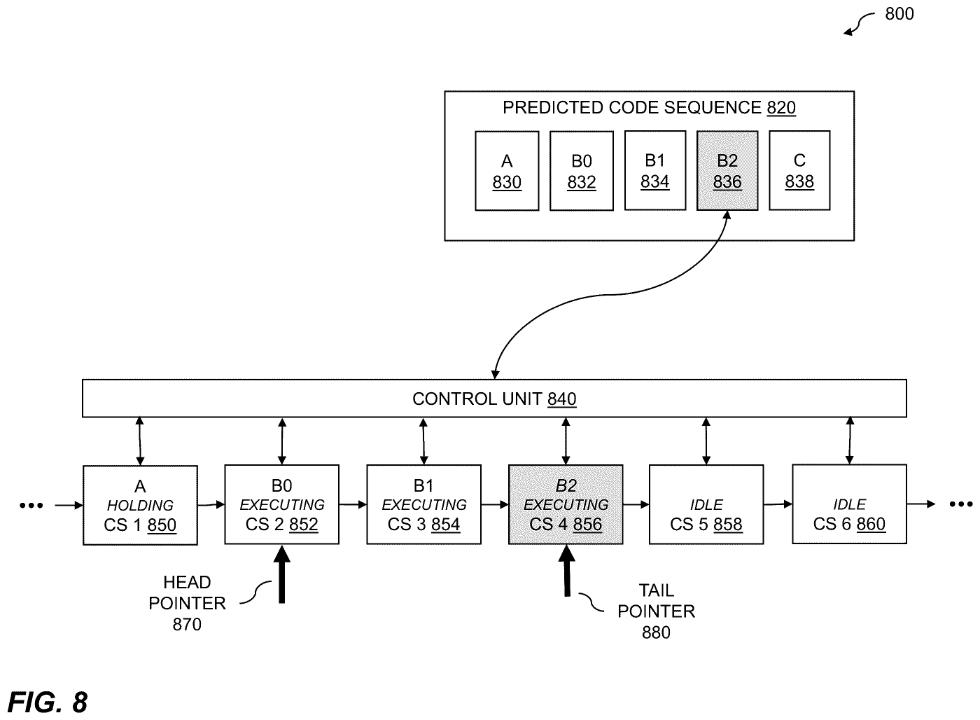

FIG. 8 is a fourth illustration of executing slice task with compute slices. In the illustration 800, further slice tasks which can include one or more instructions can be distributed and allotted to compute slices. The slice tasks that comprise the predicted code sequence can be determined from the example code 510 discussed previously. The predicted code sequence 820 can include slice tasks A 830, B0 832, B1 834, B2 836, and C 838. A control unit 840 can be coupled to one or more compute slices. The one or more compute slices can include compute slice (CS) 1 850, CS 2 852, CS 3 854, CS 4 856, CS 5 858, and CS 6 860. By the time compute slice CS 1 850 has completed executing slice task A, as discussed previously, an additional slice task from a predicted code sequence can be allotted to a fourth compute slice. The compute slice CS 1 can be put in a hold state, where the execution is complete but the “side effects” of slice task execution have not yet been committed. The side effects can include generated data, a branch decision, and so on. The data has not yet been committed or made available at the outputs of a barrier register coupled between compute slice CS 1 and compute slice CS 2 because compute slice CS 2 can still be using the data previously stored in the barrier register. Holding the data associated with compute slice CS 1 can prevent a race condition, where data being used by compute slice CS 2 would be overwritten with new data generated by compute slice CS 1.

The head pointer 870 can be updated to point to compute slice CS 2 852, since compute slice 1 850 has completed execution and has been placed in a hold state by the control unit 840. Slice task B0 can continue executing on compute slice CS 2. Slice task B1, which was previously issued by the control unit to compute slice CS 3 854, can continue executing on compute slice CS 3. Slice task B2 can be issued by the control unit 840 to a fourth compute slice, compute slice CS 4 856. Slice task B2 can begin execution on compute slice CS 4. In embodiments, the issuing of slice task B2 can be based on the branch prediction logic. The fourth compute slice is successive to a compute slice pointed to by the tail pointer. The tail pointer 880 can be updated to point to the compute slice on which slice task B2 is executing, CS 4. The remaining compute slices, CS 5 858 and CS 6 860, can remain idle. In this figure, slice task A has completed and slice tasks B0, B1, and B2 can be executing in parallel. The executing of B1 and B2 can continue while awaiting a branch decision for instruction B0 and a branch decision for instruction B2, respectively.

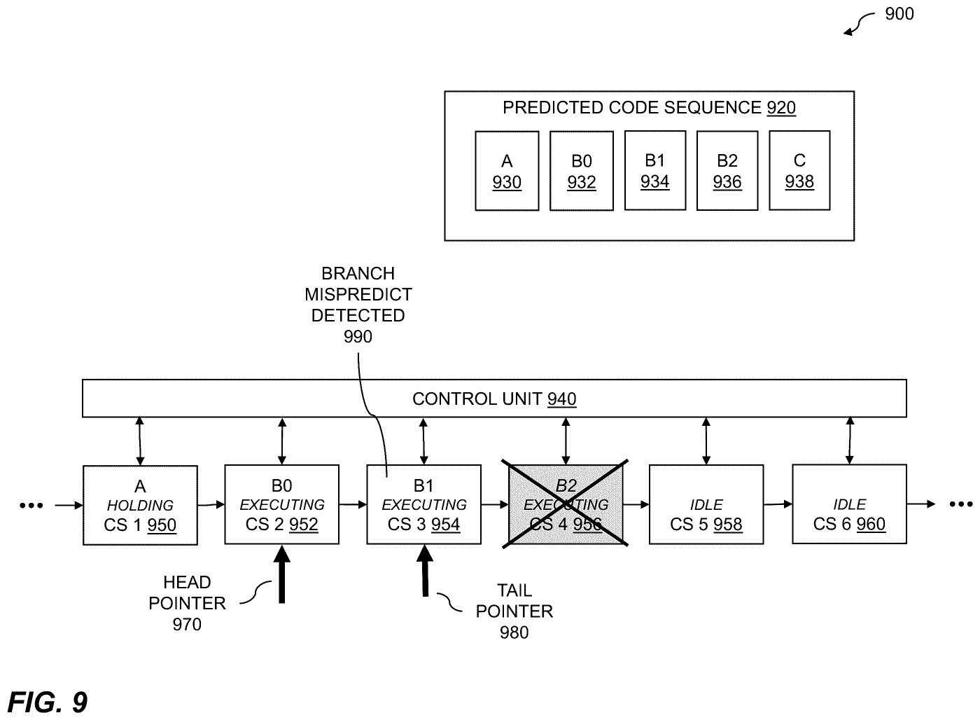

FIG. 9 is a fifth illustration of executing slice tasks with compute slices. In the illustration 900, further code slices, which can include one or more instructions, can be distributed and allotted to compute slices based on a predicted code sequence 920. The slice tasks that are distributed from the predicted code sequence can be determined from the example code 510 discussed previously. The predicted code sequence 920 can include slice tasks A 930, B0 932, B1 934, B2 936, and C 938. A control unit 940 can be coupled to one or more compute slices. The one or more compute slices can include compute slice (CS) 1 950, CS 2 952, CS 3 954, CS 4 956, CS 5 958 and CS 6 960. Discussed previously, compute slice CS 1 950 has completed executing slice task A and has been placed in a holding state where the execution side effects have not been committed to the outputs of the barrier register set coupled between compute slice CS 1 and compute slice CS 2. Execution of slice task B0 on compute slice CS 2 and slice task B1 on compute slice CS 3 can continue. Continued execution of slice tasks on compute slices can be based on whether instructions issued by the control unit are the next sequential instructions in compiled code, such as compiled programs. In the example, a branch misprediction, such as branch misprediction 990, can occur. Embodiments can include checking, by the control unit, that the slice task (e.g., slice task B2) is a next sequential slice task in the compiled program. The checking can be based on execution of the first compute slice.

As a result of the branch misprediction, the slice task B2 executing on compute slice CS 4 can be determined to not be the next sequential slice task. Embodiments can include discarding a result from the compute slice CS 4 if the slice task that was allotted to the compute slice is not the next sequential slice task in the compiled program. The discarding a result can include deleting, flushing, or ignoring the results, etc. In addition to discarding a result, the tail pointer can be updated. Embodiments can include updating the tail pointer to point to a previous slice task that is executing wherein a next sequential slice task is not distributed to the compute slice which discarded the results. In the example, the tail pointer can be updated to point to compute slice CS 3 which is executing slice task B1. The head pointer 970 can remain pointing to compute slice CS 2 952 since compute slice 1 950 has completed execution and remains in a hold state set by the control unit 940. Slice task B0 can continue executing on compute slice CS 2. Slice task B1, which was previously issued by the control unit to compute slice CS 3 954, can continue executing on compute slice CS 3. Execution of slice task B2 can be halted, suspended, etc. by setting a state associated with compute slice CS 4 to idle. Compute slice CS 4 can then become available for loading a next slice task (discussed below). The tail pointer 980 can be updated to point to the compute slice on which slice task B1 is executing, CS 3. The remaining compute slices, CS 4 956, CS 5 958, and CS 6 960 can remain idle. In this figure, slice task A has completed, and slice tasks B0 and B1 can be executing in parallel. The executing of B1 can continue while awaiting a branch decision for instruction B0.

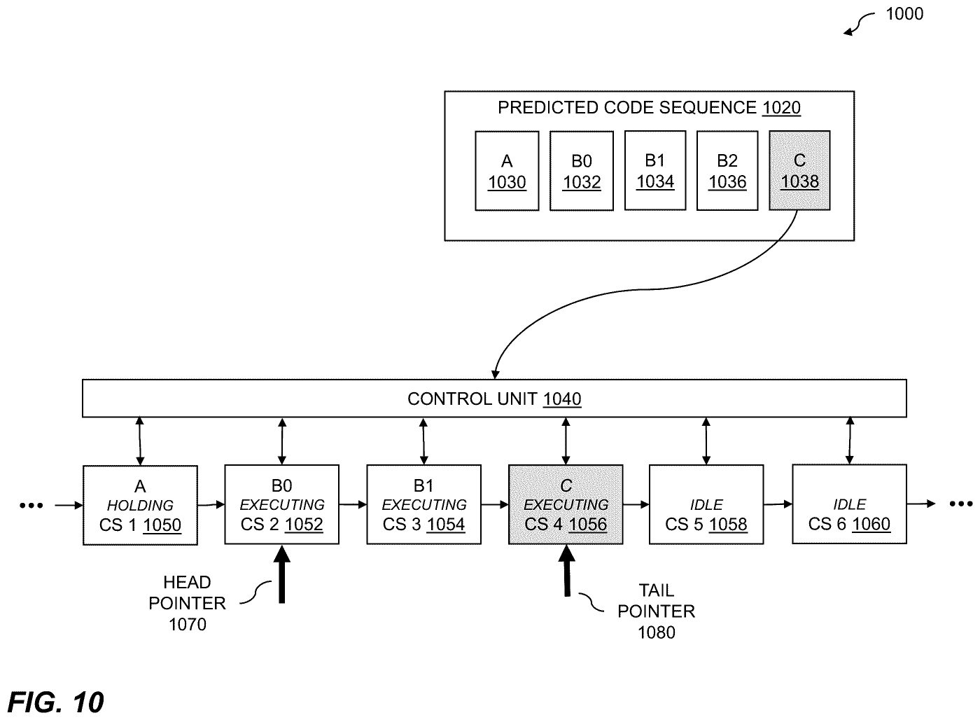

FIG. 10 is a sixth illustration of executing slice tasks with compute slices. In the illustration 1000, the control unit can be used to check whether a slice task is a next sequential slice task in a compiled program. The checking is based on execution of the first compute slice task. Since each slice task can include a branch decision, the branch decision associated with the slice task can be determined. Prior to branch decision determination, the branch decision was predicted in order to generate a predicted slice task sequence. When the branch decision is determined, the branch prediction may or may not match the branch decision. When the predicted branch decision and the branch decision match, then execution of subsequent slice tasks can continue. If the branch prediction and the branch decision do not match, then the slice task that was issued for execution can be halted or suspended, and the compute slice on which the slice task was executing can be idled and issued another slice task.

The assigning of additional slice tasks to compute slices can continue. The code slice tasks, which can be obtained from a predicted code sequence 1020, can be distributed and allotted to compute slices. The slice tasks that are distributed from the predicted code sequence can be determined from the example code 510 discussed previously. The predicted code sequence 1020 can include slice tasks A 1030, B0 1032, B1 1034, B2 1036, and C 1038. A control unit 1040 can be coupled to one or more compute slices. The one or more compute slices can include compute slice (CS) 1 1050, CS 2 1052, CS 3 1054, CS 4 1056, CS 5 1058, and CS 6 1060. Discussed previously, compute slice CS 1 1050 has completed executing slice task A. The compute slice CS 1 has been placed in a holding state, where the execution side effects have not been committed to the outputs of the barrier register set coupled between compute slice CS 1 and compute slice CS 2. Execution of slice task B0 on compute slice CS 2 and slice task B1 on compute slice CS 3 can continue. Continued execution of slice tasks on compute slices can be based on whether instructions issued by the control unit are the next sequential instructions in compiled code, such as compiled programs.

The head pointer 1070 can continue to point to compute slice CS 2 1052 since compute slice 1 1050 has completed execution and has been placed in a hold state by the control unit 1040. Slice task B0 can continue executing on compute slice CS 2. Slice task B1 can continue executing on compute slice CS 3 1054. Slice task C 1038 can be issued by the control unit 1040 to a fourth compute slice, compute slice CS 4 1056. Slice task C can begin execution on compute slice CS 4. In embodiments, the issuing of slice task C can be based on the branch prediction logic and a branch misprediction detection as discussed above. The fourth compute slice is successive to a compute slice pointed to by the tail pointer. The tail pointer 1080 can be updated to point to the compute slice on which slice task Cis executing, CS 4. The remaining compute slices, CS 5 1058 and CS 6 1060, can remain idle. In this figure, slice task A has completed and slice task B0, B1, and C can be executing in parallel. The executing of B1 and C can continue while awaiting a branch decision for slice task B0 and a branch decision for slice task B1, respectively.

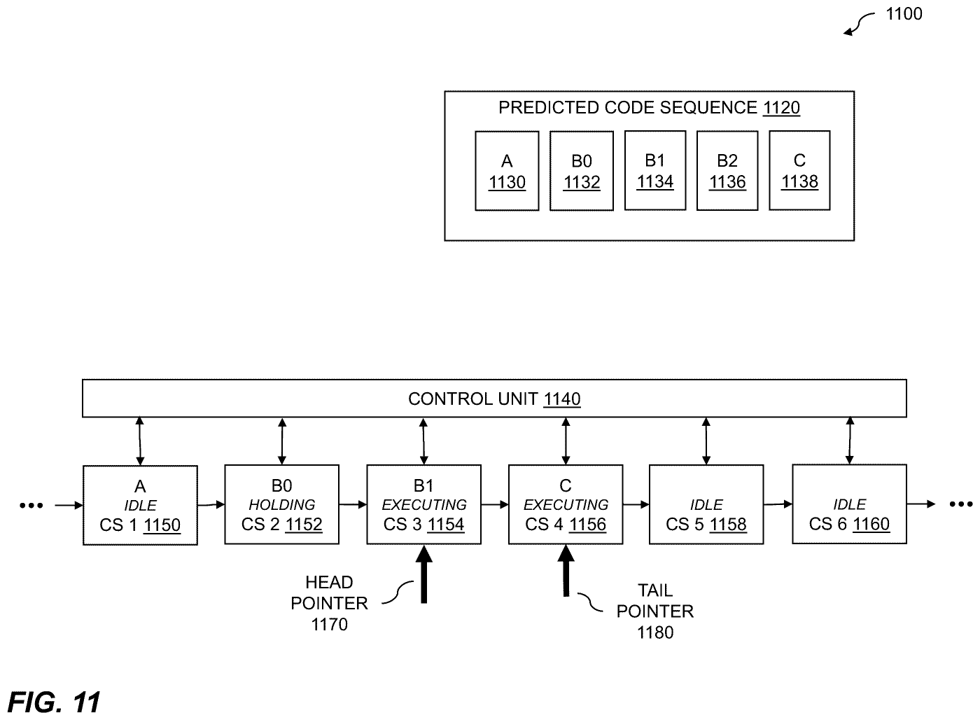

FIG. 11 is a seventh illustration of executing slice tasks with compute slices. In the illustration 1100, the slice tasks from the predicted code sequence 1120 have all been issued by the control unit 1140 to compute slices. The slice tasks that were distributed from the predicted code sequence were determined from the example code 510 discussed previously. The predicted code sequence 1120 can include slice tasks A 1130, B0 1132, B1 1134, B2 1136, and C 1138. The control unit 1140 can be coupled to one or more compute slices. The one or more compute slices can include compute slice (CS) 1 1150, CS 2 1152, CS 3 1154, CS 4 1156, CS 5 1158, and CS 6 1160. Discussed previously, compute slice CS 1 1150 has completed executing slice task A. The compute slice CS 1 and has been placed in an idle state where the execution side effects have been committed to the outputs of the barrier register set coupled between compute slice CS 1 and compute slice CS 2. Execution of slice task B0 on compute slice CS 2 has also completed execution. Compute slice CS 2 has been placed in a holding state where the execution side effects of slice task B0 have not been committed to the outputs of the barrier register set coupled between compute slice CS 2 and compute slice CS 3. Slice task B1 on compute slice CS 3 and slice task Con compute slice CS 4 can continue execution. Continued execution of slice tasks on compute slices can be based on whether slice tasks issued by the control unit are the next sequential instructions in compiled code, such as compiled programs. If further slice tasks were available for execution, then the control unit would check that any remaining slice tasks (in this example, none) are the next sequential instructions in the compiled program. The checking can be based on execution of the first compute slice. The head pointer 1170 can be updated to point to compute slice CS 3 1154, since compute slice 1 1150 has been idled and compute slice CS 2 1152 has completed execution of slice task B0 and has been placed in a hold state by the control unit 1140. Slice task B1 can continue executing on compute slice CS 3 1154. Slice task C can continue executing on compute slice CS 4 1156. The tail pointer 1180 can remain pointing to the compute slice on which slice task C is executing, CS 4. The remaining compute slices, CS 5 1158 and CS 6 1160, can remain idle. In this figure, slice task A has completed, slice task B0 can be holding, and slice tasks B1 and C can be executing in parallel.

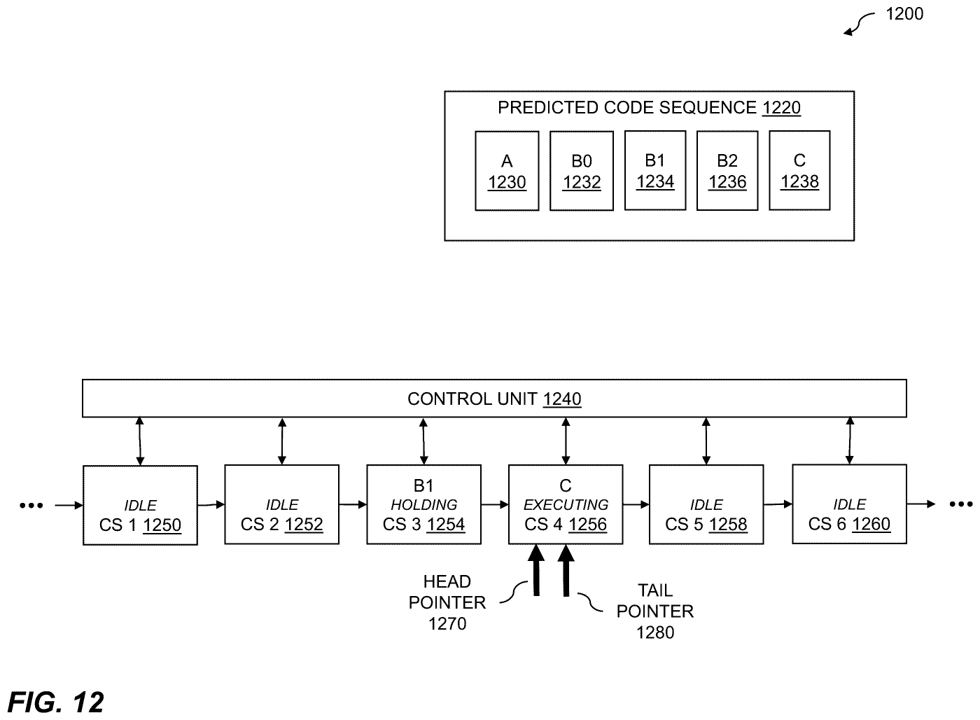

FIG. 12 is an eighth illustration of executing slice tasks with compute slices. In the illustration 1200, the control unit 1240 has issued all of the slice tasks from the predicted code sequence 1220. The slice tasks that were distributed from the predicted code sequence were determined from the example code 510 discussed previously. The predicted code sequence 1220 can include slice tasks A 1230, B0 1232, B1 1234, B2 1236, and C 1238. The control unit 1240 can be coupled to one or more compute slices. The one or more compute slices can include compute slice (CS) 1 1250, CS 2 1252, CS 3 1254, CS 4 1256, CS 5 1258, and CS 6 1260. Discussed previously, compute slices CS 1 1250 and CS 2 1252 have completed executing slice task A and slice task B0, respectively. The compute slices CS 1 and CS 2 have each been placed in an idle state. The compute slices were placed in idle states subsequent to execution side effects being committed to the outputs of the barrier register sets coupled between compute slice CS 1 and compute slice CS 2, and between compute slice CS 2 and compute slice CS 3, respectively.

Execution of slice task B1 on compute slice CS 3 has also been completed. Compute slice CS 3 has been placed in a holding state, where the execution side effects of slice task B1 have not been committed to the outputs of the barrier register set coupled between compute slice CS 3 and compute slice CS 4. Slice task C on compute slice CS 4 can continue execution. Continued execution of slice tasks on compute slices can be based on whether instructions issued by the control unit are the next sequential instructions in compiled code, such as compiled programs. If further slice tasks were available for execution, then the control unit would check that any remaining instructions (in this example, none) are the next sequential slice tasks in the compiled program. The checking can be based on execution of the first compute slice. The head pointer 1270 can be updated to point to compute slice CS 4 1256 since compute slice 1 1250 has been idled, compute slice CS 2 1252 has been idled, and compute slice CS 3 has completed execution of slice task B1 and has been placed in a hold state by the control unit 1240. Slice task C can continue executing on compute slice CS 4 1256. The tail pointer 1280 can remain pointing to the compute slice on which slice task Cis executing, CS 4. The remaining compute slices, CS 5 1258 and CS 6 1260, can remain idle. In this figure, slice task A has completed, slice task B0 has completed, slice task B1 can be holding, and slice task C can be executing.

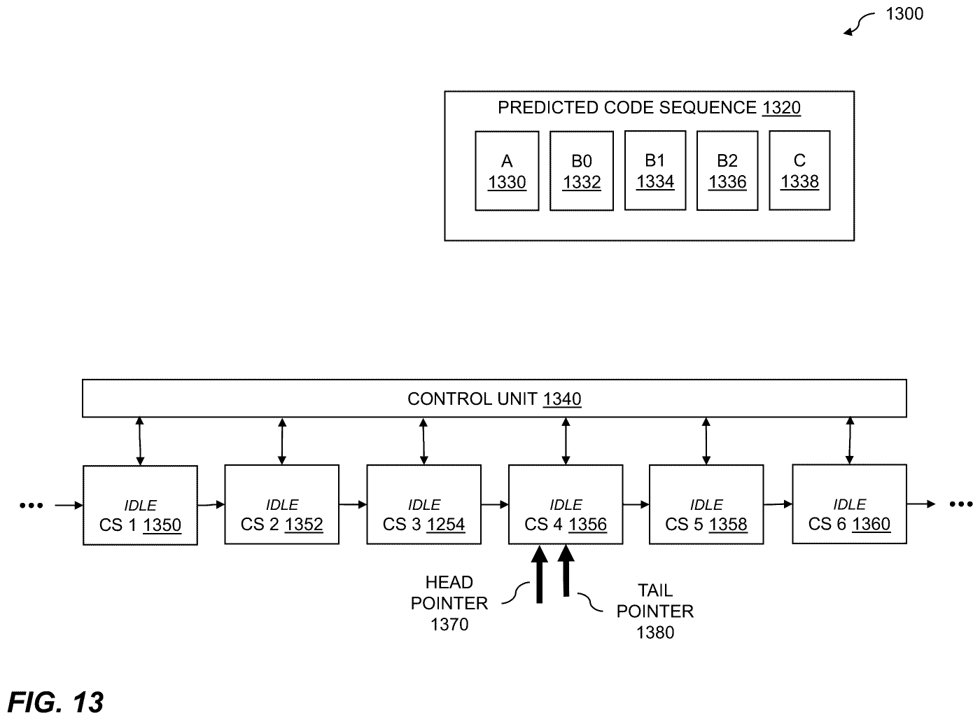

FIG. 13 is a ninth illustration of executing slice tasks with compute slices. In the illustration 1300, the control unit 1340 has issued all of the slice tasks from the predicted code sequence 1320. The slice tasks that were distributed from the predicted code sequence were determined from the example code 510 discussed above. The predicted code sequence 1320 can include slice tasks A 1330, B0 1332, B1 1334, B2 1336, and C 1338. The control unit 1340 can be coupled to one or more compute slices. The one or more compute slices can include compute slice (CS) 1 1350, CS 2 1352, CS 3 1354, CS 4 1356, CS 5 1358, and CS 6 1360. In this figure, all the compute slices to which slice tasks were issued by the control unit 1340 have completed execution of the issued slice tasks. Further, since all instructions have been executed, then execution side effects of the slice tasks have been or can be committed to the outputs of the barrier register sets coupled between the compute slices. The compute slices to which the slice tasks were issued can all be returned to an idle state. The remaining compute slices CS 5 1358 and CS 6 1360, which were not previously issued slice tasks by the control unit, can remain idle. The head pointer 1370 can be updated to point to compute slice CS 4, and the tail pointer 1380 can remain pointing to compute slice CS 4. The processor slices can remain in an idle state until a new code can be provided to a processing unit such as the processing unit described herein. When the new code is provided, then a new predicted code sequence can be determined. The slice tasks within the predicted code sequence can be issued by the control unit to one or more compute slices.

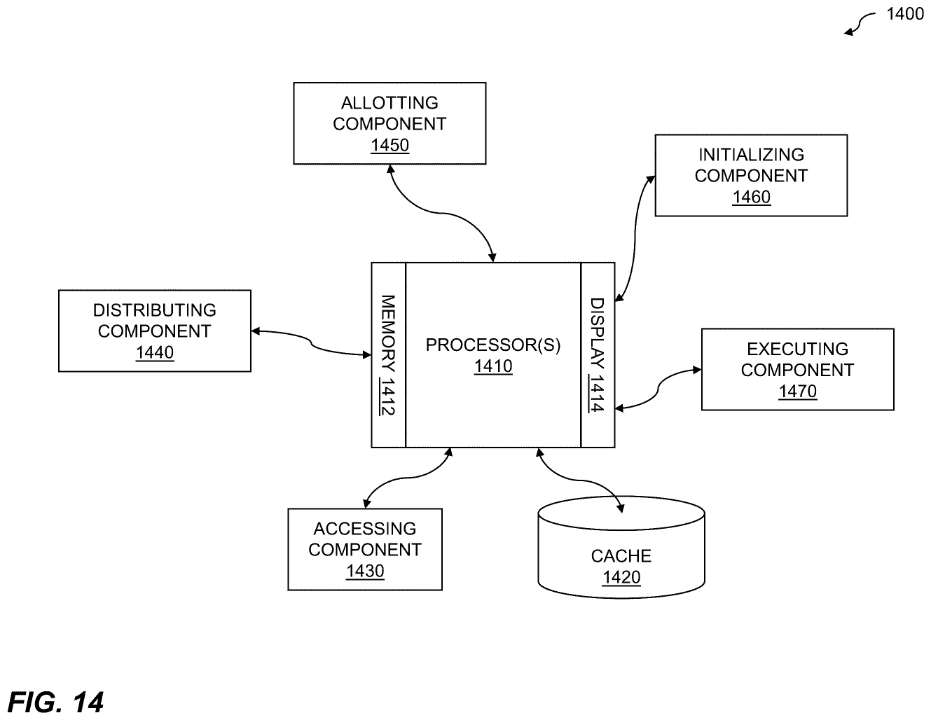

FIG. 14 is a system diagram for computer processing. The computer processing is enabled by a parallel architecture with compiler-scheduled compute slices. The system 1400 can include one or more processors 1410, which are coupled to a memory 1412 which stores instructions. The system 1400 can further include a display 1414 coupled to the one or more processors 1410 for displaying data; intermediate steps; slice task slices; topologies including systolic, vector, cyclic, spatial, streaming, or VLIW topologies; and so on. In embodiments, one or more processors 1410 are coupled to the memory 1412, wherein the one or more processors, when executing the instructions which are stored, are configured to: access a processing unit comprising a plurality of compute slices, a plurality of barrier register sets, a control unit, and a memory system, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices; distribute a first slice task, by the control unit, to a first compute slice in the plurality of compute slices; allot a second slice task, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets; initialize pointers, wherein a head pointer points to the first compute slice, and wherein a tail pointer points to the second compute slice; and execute a compiled program, wherein the executing begins at the first compute slice. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 1400 can include a cache 1420. The cache 1420 can be used to store data such as scratchpad data, slice tasks for compute slices, operations that support a balanced number of execution cycles for a data-dependent branch; intermediate results; microcode; branch decisions; and so on. The cache can comprise a small, local, easily accessible memory available to one or more compute elements. In embodiments, the data that is stored can include operations, data, and so on. The system 1400 can include an accessing component 1430. The accessing component 1430 can include control logic and functions for accessing a processing unit. The processing unit can be accessible within an integrated circuit, an application-specific integrated circuit (ASIC), a programmable unit such as a field-programmable gate array (FPGA), and so on. The processing unit can comprise a plurality of compute slices, a plurality of barrier register sets, a control unit, and a memory system. Each compute slice within the plurality of compute slices includes at least one execution unit. A compute slice can include one or more processors, processor cores, processor macros, processor cells, and so on. Each compute slice can include an amount of local storage. The local storage may be accessible by one or more compute slices. The compute slices can be organized in a ring. Compute slices within the ring can be accessed using pointers. The pointers can include a head pointer, a tail pointer, and the like. Each compute slice is coupled to a successive compute slice and a predecessor compute slice by a barrier register set in the plurality of barrier register sets. The barrier register set provides for communication of data between successive compute slices. Communication between and among compute slices can be accomplished using a bus such as an industry standard bus, a ring bus, a network such as a wired or wireless computer network, etc. In embodiments, the ring bus is implemented as a distributed multiplexor (MUX).

The system 1400 can include a distributing component 1440. The distributing component 1440 can include control and functions for distributing a first slice task to a first compute slice in the plurality of compute slices. The distributing can be accomplished using a bus, a network such as a network-on-chip (NOC), and so on. The distributing is accomplished by the control unit. The control unit can distribute the first slice task. The distributing the first slice task for the first compute slice can be accomplished by using the head pointer. The head pointer can point to the next available compute slice in the ring of compute slices.

The system 1400 can include an allotting component 1450. The allotting component 1450 can include control and functions for allotting a second slice task to a second compute slice in the plurality of compute slices. The allotting can also be accomplished using a bus, a network, etc. The allotting can be performed by the control unit. The allotting can be based on a branch prediction logic within the control unit. The branch prediction logic can predict which branch path will be taken when a branch decision is made and allot the second slice code based on that prediction. The second compute slice in the plurality of compute slices can be allotted based on a pointer such as a tail pointer. The second compute slice is coupled to the first compute slice by a first barrier register set in the plurality of barrier register sets. The first barrier register set can hold data generated by the first slice task, data required by the second slice task, etc. The first barrier register set can include one or more two-stage buffers. In a usage example, data can be loaded into the first barrier register set and can be available at the output of the first barrier register set for processing by the second slice task. Data can be generated by the first slice task as the first slice task is executed. The data generated by the first slice task can be loaded into, accumulated by, etc. an input stage of the first barrier register set. The data in the input stage of the first barrier set can be transferred to the output of the first barrier set based on a signal, a flag, and so on. The data can be transferred based on a decision such as a branch decision.

The system 1400 can include an initializing component 1460. The initializing component 1460 can include control and functions for initializing pointers. The pointers can include two or more pointers. The pointers can each point to a compute slice within the plurality of compute slices. A head pointer points to the first compute slice, and a tail pointer points to the second compute slice. The pointers can both point to the same compute slice when no compute slice blocks are loaded with slice tasks. The pointers can be updated. Embodiments can include updating the tail pointer to point to the second compute slice. In a usage example, the head pointer and the tail pointer point to the same compute slice. A first slice task can be distributed to the compute slice pointed to by the head pointer. A second slice task can be allocated to the next available compute slice that can be coupled to the first compute slice by a first barrier register set. Embodiments include updating the tail pointer to point to the second compute slice. The second compute slice can be the compute slice to which the second slice task can be allocated. Discussed below, the pointers can be updated based on completing execution of a slice task. The updating pointers can continue as further slice tasks are allocated to compute slices. Embodiments can include issuing a third slice task, by the control unit, to a third compute slice in the plurality of compute slices, wherein the issuing is based on the branch prediction logic, and wherein the third compute slice is successive to a compute slice pointed to by the tail pointer.

The system 1400 can include an executing component 1470. The executing component 1470 can include control and functions for executing a compiled program. The program can include a plurality of slice tasks, where the slice tasks can be determined by the compiler. The slice tasks that are executed, where each slice task can include at least one branch operation, can be determined based on predicted or speculative branch outcomes. Recall that a first slice task can be distributed to a first compute slice, a second slice task can be allotted to a second compute slice, and so on. The executing begins at the first compute slice. While one slice task can be executed, more than one slice task can be executed in parallel. The executing a code slice can generate data for an additional slice task. The executing a slice task can determine an actual branch decision as opposed to the predicted branch decision. Execution of slice tasks that depend on the outcome of the first slice task branch decision can continue execution when the branch prediction and the branch outcome are substantially similar. Other actions can be taken if the branch prediction and the branch outcome are substantially different. Embodiments can include ignoring a result from the second compute slice, wherein a branch instruction in the first compute slice was mispredicted by the branch prediction logic. Since the branch prediction for the first compute slice was incorrectly predicted by the branch prediction logic, then the slice task running on the second compute slice, which was based on the incorrectly predicted branch path of the first slice, becomes irrelevant. Further embodiments can include flushing, in the second compute slice, information stored in a write buffer. Further actions can be taken based on the branch misprediction. Embodiments can include updating the tail pointer to point to the first compute slice, wherein a next sequential slice task is not distributed to the second compute slice.

Discussed previously, results from a compute slice such as the second compute slice can be ignored when a branch instruction in a compute slice such as the first compute slice is mispredicted. Embodiments can include committing a result of the first compute slice, by the control unit, wherein the first compute slice has completed execution. Committing a result of the first compute slice can include loading the result into a barrier register set and making the result available at the output of the barrier register set. The next compute slice in a sequence of compute slices can access the data. Embodiments can include checking, by the control unit, that the second slice task is a next sequential slice task in the compiled program. The checking is based on execution of the first compute slice. Recall that slice tasks can be generated by the compiler and assigned to compute slices based on predicted branch outcomes. If the second slice task is determined to be the next sequential slice task, then the data that was committed to the barrier register can be accessed by the second slice task. Other embodiments can include discarding a result from the second compute slice if the second slice task that was allotted to the second compute slice is not the next sequential slice task in the compiled program. In a usage example, the second slice task, which can have been executing while the first slice task was executing, can be the incorrect slice task due to a mispredicted branch result. The correct slice task can be assigned. Embodiments can include assigning, to the second compute slice, the next sequential slice task in the compiled program. The assigning can be accomplished by the control unit.

Discussed previously, further slice tasks can be assigned to compute slices. Embodiments can include issuing a third slice task, by the control unit, to a third compute slice in the plurality of compute slices. The issuing can be based on the branch prediction logic, and the third compute slice can be successive to a compute slice pointed to by the tail pointer. Continuing execution can be based on which compute slices have completed execution of their slice tasks, which compute slices are still executing code, and so on. In embodiments, the second compute slice completes execution of the second slice task, and wherein the first compute slice has not completed execution. The completing execution of the second slice task can include determining a branch decision associated with the second slice task. Embodiments can include checking, by the control unit, that the third slice task is a next sequential slice task in the compiled program, based on the execution of the second compute slice which was completed. Based on the branch decision determined by the second slice task, the third slice task is the next sequential slice task. Further, the third slice task was correctly predicted to be the next sequential slice task. However, the third slice task may have been mispredicted to be the next sequential slice task. Further embodiments include setting the third compute slice to an idle state if the third slice task that was issued is not the next sequential slice task in the compiled program. Since the third slice task will not be executed, one or more pointers can be updated. Embodiments can include updating the tail pointer to point to the second compute slice, wherein the next sequential slice task is not distributed to the third compute slice.

Slice tasks can generate data that can be written or stored into registers, slice tasks read or loaded from registers, and so on. Embodiments can include writing, by the first compute slice, to one or more registers within the first barrier register set, one or more results from the first slice task which are required inputs for the second slice task. The registers can include registers such as two-stage registers with a barrier register set. The writing of data can occur at various times, cycles, and so on of execution of a slice task. In embodiments, the writing can occur on or before an end of execution of the first slice task. The data can be written as the data is generated, can be held in a buffer and promoted when execution completes, and so on. Further embodiments can include reading, by the second compute slice, from the one or more registers within the first barrier register set, the one or more results from the first slice task. The reading can be based on the second compute slice being the predicted slice task. The data to be read by the second slice task may or may not be available when an access request is generated by the second compute slice. Embodiments can include stalling, by the second compute slice, until one or more results from the first slice task, which are required inputs for the second slice task, are updated by the first compute slice.

Discussed previously and throughout, the processing unit can include compute slices, a barrier register set, a control unit, a memory system, and so on. Slice tasks can be assigned to compute slices for execution. The slice tasks can include one or more operations. In embodiments, the first slice task and the second slice task can include a plurality of instructions and at least one branch instruction. The instructions can perform logical operations; arithmetic, matrix, or tensor operations; and the like. The elements associated with the processing unit can be configured in a variety of orientations, topologies, configurations, etc. In embodiments, the plurality of compute slices and the plurality of barrier register sets can be coupled in a ring configuration. The ring configuration can simplify the distributing and allotting of slice tasks to compute slices. The distributing and allotting can be enabled by pointers such as the head pointer and the tail pointer. The compute slices can be in one of a variety of states associated with presence or absence of a slice task, can be waiting for data, can be generating data, and so on. Embodiments can include assigning, by the control unit, a state to each compute slice in the plurality of compute slices. The state assigned by the control unit is one of idle, executing, holding, or done. The assigned state can be changed by the control unit based on code execution, data accesses, branch decisions, etc.

An exception can occur while executing a slice task on a compute slice. Embodiments can include setting an exception flag, by at least one compute slice in the plurality of compute slices, wherein a slice task distributed to the at least one compute slice caused an exception to occur. An exception can include an unexpected behavior or result, an illegal or undefined operation such as division by zero, and so on. An exception can be handled by exception handling hardware, software, and the like. An exception can include a recoverable exception or an unrecoverable exception. Various actions can be taken based on the setting of an exception flag. Embodiments can include waiting, by the at least one compute slice, until the head pointer indicates that the at least one compute slice is active. If no indication of an active compute slice is received, then an action such as abnormal termination of a task can be taken. Data, states, and so on associated with slice tasks can be ignored, purged, saved, etc. Embodiments include discarding a state of the at least one compute slice, wherein the exception is not recoverable. That is, the cause of the exception cannot be resolved so recovery from the exception is not possible. Other embodiments can include saving, by the control unit, the state of the at least one compute slice, wherein the exception is recoverable. The saved state can enable continuation of execution of a slice task upon resolution of the exception. Embodiments can include handling the exception, wherein the exception is recoverable. The handling the exception can include locating missing data, resolving an operation precedence conflict, etc. In a usage example, a recoverable exception can include handling a higher priority operation before returning to normal operation. Further embodiments include restoring, by the control unit, the state that was saved to the at least one compute slice. The restoring state can restore data, register contents, a pointer to the instruction executing at the point of the exception, and so on. The restoring can enable the compute slice to continue execution of a slice task. Embodiments include restarting execution, by the at least one compute slice, of the slice task that was distributed.

A task that is being executed can include one or more data dependent branch operations. A branch operation can include two or more branches. Recall that slice tasks such as a second slice task, a third slice task, and so on are distributed, allotted, etc. to compute slices based on branch prediction logic. A branch path is selected based on an operation such as an arithmetic or logical operation. In a usage example, a branch operation can determine the outcome of an expression such as A>B. If A is greater than B, then one branch can be taken. If A is less than or equal to B, then another branch can be taken.

In embodiments, the compiler can calculate a latency for a data dependent branch operation. Since execution of the at least two operations is impacted by latency, the latency can be scheduled into compute slice operations. In order to further speed execution of a branch operation, sides of the branch can be precomputed prior to datum A and datum B being available. When the data is available, the expression can be computed (which is a form of predication), and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the accessing, the providing, the loading, and the executing enable background memory accesses. The background memory access enables a control element to access memory independently of other compute elements, a controller, etc. In embodiments, the background memory accesses can reduce load latency. Load latency is reduced since a compute slice can access memory before the compute element exhausts the data that the compute element is processing.

The system 1400 can include a computer program product embodied in a non-transitory computer readable medium for task processing, the computer program product comprising code which causes one or more processors to perform operations of: accessing a processing unit comprising a plurality of compute slices, a plurality of barrier register sets, a control unit, and a memory system, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices; distributing a first slice task, by the control unit, to a first compute slice in the plurality of compute slices; allotting a second slice task, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets; initializing pointers, wherein a head pointer points to the first compute slice, and wherein a tail pointer points to the second compute slice; and executing a compiled program, wherein the executing begins at the first compute slice.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing a processing unit comprising a plurality of compute slices, a plurality of barrier register sets, a control unit, and a memory system, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices;
distributing a first slice task, by the control unit, to a first compute slice in the plurality of compute slices;
allotting a second slice task, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets;
initializing pointers, wherein a head pointer points to the first compute slice, and wherein a tail pointer points to the second compute slice; and
executing a compiled program, wherein the executing begins at the first compute slice.

2. The method of claim 1 further comprising ignoring a result from the second compute slice, wherein a branch instruction in the first compute slice was mispredicted by the branch prediction logic.

3. The method of claim 2 further comprising flushing, in the second compute slice, information stored in a write buffer.

4. The method of claim 3 further comprising updating the tail pointer to point to the first compute slice, wherein a next sequential slice task is not distributed to the second compute slice.

5. The method of claim 1 further comprising committing a result of the first compute slice, by the control unit, wherein the first compute slice has completed execution.

6. The method of claim 5 further comprising checking, by the control unit, that the second slice task is a next sequential slice task in the compiled program, wherein the checking is based on execution of the first compute slice.

7. The method of claim 6 further comprising discarding a result from the second compute slice if the second slice task that was allotted to the second compute slice is not the next sequential slice task in the compiled program.

8. The method of claim 7 further comprising assigning, to the second compute slice, the next sequential slice task in the compiled program, wherein the assigning is accomplished by the control unit.

9. The method of claim 8 further comprising updating the tail pointer to point to the second compute slice.

10. The method of claim 1 further comprising issuing a third slice task, by the control unit, to a third compute slice in the plurality of compute slices, wherein the issuing is based on the branch prediction logic, and wherein the third compute slice is successive to a compute slice pointed to by the tail pointer.

11. The method of claim 10 wherein the second compute slice completes execution of the second slice task, and wherein the first compute slice has not completed execution.

12. The method of claim 11 further comprising checking, by the control unit, that the third slice task is a next sequential slice task in the compiled program, based on the execution of the second compute slice which was completed.

13. The method of claim 12 setting the third compute slice to an idle state if the third slice task that was issued is not the next sequential slice task in the compiled program.

14. The method of claim 13 further comprising updating the tail pointer to point to the second compute slice, wherein a next sequential slice task is not distributed to the third compute slice.

15. The method of claim 1 further comprising writing, by the first compute slice, to one or more registers within the first barrier register set, one or more results from the first slice task which are required inputs for the second slice task.

16. (canceled)

17. The method of claim 15 further comprising reading, by the second compute slice, from the one or more registers within the first barrier register set, the one or more results from the first slice task.

18. The method of claim 1 further comprising stalling, by the second compute slice, until one or more results from the first slice task, which are required inputs for the second slice task, are updated by the first compute slice.

19. The method of claim 1 wherein the first slice task and the second slice task include a plurality of instructions and at least one branch instruction.

20. The method of claim 1 wherein the plurality of compute slices and the plurality of barrier register sets are coupled in a ring configuration.

21. The method of claim 1 further comprising assigning, by the control unit, a state to each compute slice in the plurality of compute slices, wherein the state is one of idle, executing, holding, or done.

22. The method of claim 1 further comprising setting an exception flag, by at least one compute slice in the plurality of compute slices, wherein a slice task distributed to the at least one compute slice caused an exception to occur.

23. The method of claim 22 further comprising waiting, by the at least one compute slice, until the head pointer indicates that the at least one compute slice is active.

24. (canceled)

25. The method of claim 23 further comprising saving, by the control unit, a state of the at least one compute slice, wherein the exception is recoverable.

26. The method of claim 25 further comprising handling the exception, wherein the exception is recoverable.

27-28. (canceled)

29. A computer program product embodied in a non-transitory computer readable medium for task processing, the computer program product comprising code which causes one or more processors to perform operations of:
accessing a processing unit comprising a plurality of compute slices, a plurality of barrier register sets, a control unit, and a memory system, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices;
distributing a first slice task, by the control unit, to a first compute slice in the plurality of compute slices;
allotting a second slice task, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets;
initializing pointers, wherein a head pointer points to the first compute slice, and wherein a tail pointer points to the second compute slice; and
executing a compiled program, wherein the executing begins at the first compute slice.

30. A computer system for task processing comprising:
a memory which stores instructions;
one or more processors coupled to the memory, wherein the one or more processors, when executing the instructions which are stored, are configured to:
access a processing unit comprising a plurality of compute slices, a plurality of barrier register sets, a control unit, and a memory system, wherein each compute slice within the plurality of compute slices includes at least one execution unit, and is coupled to a successive compute slice and a predecessor compute slice by a barrier register set in the plurality of barrier register sets, wherein the barrier register set provides for communication of data between successive compute slices;
distribute a first slice task, by the control unit, to a first compute slice in the plurality of compute slices;
allot a second slice task, by the control unit, to a second compute slice in the plurality of compute slices, wherein the allotting is based on a branch prediction logic within the control unit, and wherein the second compute slice is coupled to the first compute slice by a first barrier register set in the plurality of barrier register sets;
initialize pointers, wherein a head pointer points to the first compute slice, and wherein a tail pointer points to the second compute slice; and
execute a compiled program, wherein the executing begins at the first compute slice.
